(19) United States
(12) Patent Application Publication
(10) Pub. No.: US 2010/0082208 A1
(43) Pub. Date: Apr. 1, 2010

(54) CONTROL SYSTEM FOR AUTOMATIC TRANSMISSION

(75) Inventors: Masahiro ASAI, Anjo-shi (JP); Keiichirou KUSABE, Anjo-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/560,692

(22) Filed: Sep. 16, 2009

(30) Foreign Application Priority Data
Sep. 30, 2008 (JP) 2008-255694

(51) Int. Cl. G06F 19/00

(52) U.S. Cl. 701/58

(57) ABSTRACT

An automatic transmission control system calculates a sustention output, needed to sustain a vehicle speed, based on the running resistance, calculates a request output based on, for example, an accelerator pedal angle, calculates a current gear ratio maximum output, which is a maximum output of a vehicle at the current gear ratio, based on the maximum output performance of the engine, and also calculates a post-upshift maximum output that is the maximum output of the vehicle at a gear ratio resulting from an upshift. When a first value based on the sustention output, request output, and a reserve output becomes larger than a second value based on the current gear ratio maximum output, a downshift is decided. When a third value based on the sustention output, request output, and reserve output becomes smaller than a fourth value based on a post-upshift maximum output, upshift is decided.

### BACKGROUND OF THE INVENTION

1. Field of the Invention

The present invention relates to a control system for an automatic transmission mounted in a vehicle or the like. More particularly, the present invention is concerned with a control system for an automatic transmission which selects a gear ratio in a speed changing mechanism by performing computation.

2. Description of Related Art

In general, for a multistage automatic transmission mounted in a vehicle or the like, shift maps are determined (prepared) in advance in the course of manufacture. While the vehicle is run, the shift maps are referenced based on a vehicle speed and an accelerator pedal angle in order to select (decide) a speed stage. For example, multiple kinds of maps including maps associated with running resistances occurring on, for example, a flat road, an uphill road, and a downhill road, and maps associated with different driver types, for example, a sporty type, a normal type, and an economic type may be prepared so that gear-shifting decision will be made appropriately.

In recent years, further improvement in fuel consumption by a vehicle and improvement in fuel consumption by an automatic transmission have been requested in terms of environmental problems. In order to improve the fuel consumption by the automatic transmission, the vehicle has to upshift to select a higher speed stage in a stage in which the vehicle speed is still low, and has to run with the engine speed held low. However, when the speed stage is shifted to the higher speed stage with the engine speed held low, there is no tolerance for, for example, a change in the gradient of a road, a change in the condition of the road, or a change in a driver's action performed on an accelerator pedal. The frequency at which downshift is immediately needed because running at the speed stage is not sustained increases. Namely, busy shifting, that is, an event that gear shifting is frequently repeated is likely to occur. This poses a problem in that drivability is impaired.

In order to solve the problem, that is, in order to improve fuel consumption while ensuring drivability, the foregoing shift maps are further classified in order to prepare numerous shift maps, for example, more than one hundred kinds of shift maps. The numerous shift maps are switched timely so that an optimal speed stage can be selected in line with a situation at a specific time (a running resistance, a driver type or the like). Thus, gear-shifting decision may be optimized. However, feasibility is poor because such numerous shift maps have to be prepared or the shift maps have to be switched or controlled.

As described in patent document 1, selection or determination of a speed stage may presumably be achieved through computation. In the patent document 1, when a vehicle is run using an automatic speed regulation facility (so-called cruise control), whether a vehicle speed can be sustained is computed based on a driving force fed from an engine, a running resistance received by the vehicle, and a reserve driving force (see, for example, FIG. 1 in JP-T-2006-507459). If the vehicle speed cannot be sustained, downshift is commanded. If the vehicle speed may presumably not be sustained after upshift is performed, upshift is inhibited. In other cases, upshift is enabled.

However, according to JP-T-2006-507459, a gear ratio is selected during cruise control. Therefore, although selection of the gear ratio permitting a vehicle speed to remain substantially constant may be achieved through computation, when a vehicle is normally driven by a driver, the selection of the gear ratio may not be achieved through computation. In other words, assuming that a vehicle in which gear shifting control based on a computation technique disclosed in, for example, JP-T-2006-507459 is implemented is run, when a driving force for an engine is increased by stepping on an accelerator pedal, the driving force for the engine immediately exceeds a running resistance (and a reserve driving force) to be received by the vehicle. Since upshift is immediately permitted, the vehicle is not accelerated as it is intended. The technique for selecting a gear ratio through computation has not yet been established. A feasible computation technique for selecting a gear ratio has been demanded.

### SUMMARY OF THE INVENTION

An object of the present invention is to provide a control system for an automatic transmission making it possible to select a gear ratio through computation without impairment of drivability and the necessity of shift maps, and thus achieve improvement in fuel consumption.

The present invention (see, for example, FIG. 1 to FIG. 31) is directed to a control system (1) for an automatic transmission (3), in which a gear ratio in a speed changing mechanism (5) that changes the number of revolutions inputted from a driving source (2) to an input shaft (10) and outputs the resultant revolutions from an output shaft (11) to driving wheels, can be freely changed, including:

a sustention output calculation means (33) that calculates a sustention output (balanced_pwr), which is needed to sustain a vehicle speed (outRpm), on the basis of a running resistance (roadR);

a request output calculation means (32) that calculates a requested request output (req_pwr);

a current gear ratio maximum output calculation means (41) that calculates a current gear ratio maximum output (n_MAXpwr), which is a maximum output of a vehicle at a current gear ratio, on the basis of a maximum output (E/G_MAXpwr) of the driving source (2);

a post-upshift maximum output calculation means (43) that calculates a post-upshift maximum output (n+_MAXpwr), which is a maximum output of the vehicle at a gear ratio resulting from upshift, on the basis of the maximum output (E/G_MAXpwr) of the driving source (2);

a downshift decision means (51) that when a first value based on the sustention output (balanced_pwr), the request output (req_pwr), and a reserve output (reserved_pwr) needed to give a tolerance for a change in a running situation, which helps decide gear shifting, gets larger than a second value based on the current gear ratio maximum output (n_MAXpwr), decides downshift to change the gear ratio; and

an upshift decision means (52) that when a third value based on the sustention value (balanced_pwr), the request output (req_pwr), and the reserve output (reserved_pwr) gets smaller than a fourth value based on the post-upshift maximum output (n+_MAXpwr), decides upshift to change the gear ratio.

Within a domain of values of an accelerator pedal angle to be designated when, for example, a driver does not want to accelerate a vehicle but sustains a vehicle speed, a gear ratio is selected based on the sustention output and reserve output associated with a running resistance received by the vehicle. Within a domain of values of the accelerator pedal angle designated when, for example, the driver wants to accelerate the vehicle, since the gear ratio is selected based on the request output, improvement in fuel consumption can be achieved in a running state in which the vehicle speed is sustained, and the gear ratio can be selected in response to the driver' s acceleration request. Eventually, drivability can be ensured. Thus, no shift map is needed but feasible computation for selection of the gear ratio can be achieved. In other words, a new computation technique for selecting the gear ratio can be provided. Since selection of the gear ratio through computation is enabled, if gear ratio selection control is intensified by, for example, optimizing numerical values for computation, correcting the numerical values according to a running situation, and learning the numerical values, further improvement in fuel consumption can be achieved.

Specifically, in the present invention (see, for example, FIG. 17 to FIG. 22),

the downshift decision means (51) may adopts as the first value (MAX[(balanced_pwr+reserved_pwr),req_pwr]) a larger one of an output, which is obtained by adding the reserve output (reserved_pwr) to the sustention output (balanced_pwr), and the request output (req_pwr); and

the upshift decision means (52) may adopt as the third value (MAX[(balanced_pwr+reserved_pwr),req_pwr]+hys_pwr) an output that is obtained by adding a predetermined output (hys_pwr) needed to prevent hunting to the larger one of the output, which is obtained by adding the reserve output (reserved_pwr) to the sustention output (balanced_pwr), and the request output (req_pwr).

Thus, the larger one of the output obtained by adding the reserve output to the sustention output and the request output is adopted as the first value to be used to decide downshift. The output obtained by adding the predetermined output, which is needed to prevent hunting, to the larger one of the output, which is obtained by adding the reserve output to the sustention output, and the request output is adopted as the third value to be used to decide upshift. Thus, in a running state in which a vehicle speed is sustained, both prevention of busy shift and improvement in fuel consumption can be achieved based on the reserve output. In a running state in which a driver requests acceleration, a gear ratio associated with the request output can be selected.

Specifically, in the present invention (see, for example, FIG. 28 and FIG. 29)

the downshift decision means (51) may adopt as the first value (balanced_pwr+MAX[reserved_pwr,req_pwr]) an output obtained by adding up the sustention output (balanced_pwr) and a larger one of the reserve output (reserved_pwr) and request output (req_pwr); and

the upshift decision means (52) may adopt as the third value (balanced_pwr+MAX[reserved_pwr,req_pwr]+hys_pwr) an output obtained by adding up the sustention output (balanced_pwr), the larger one of the reserve output (reserved_pwr) and request output (req_pwr) and a predetermined output (hys_pwr) needed to prevent hunting.

The output obtained by adding the larger one of the reserve output and request output to the sustention output may be adopted as the first value for use in deciding downshift, and the output obtained by adding the predetermined output, which is needed to prevent hunting, to the output obtained by adding the larger one of the reserve output and request output to the sustention output may be adopted as the third value for use in deciding upshift. Therefore, in a running state in which a vehicle speed is sustained, both prevention of busy shift and improvement in fuel consumption can be achieved based on the reserve output. In a running state in which a driver requests acceleration, a gear ratio associated with the request output can be selected.

Specifically, in the present invention (see for example, FIG. 17 to FIG. 22),

the downshift decision means (51) may adopt the current gear ratio maximum output (n_MAXpwr) as the second value; and

the upshift decision means (52) may adopt the post-upshift maximum output (n+_MAXpwr) as the fourth value.

The current gear ratio maximum output may be adopted as the second value serving as a reference for deciding downshift, and the post-upshift maximum output may be adopted as the fourth value serving as a reference for deciding upshift. Therefore, if a vehicle speed is not sustained any longer because the sustention will exceed the output ability of a vehicle at a current gear ratio, or if acceleration is requested although the acceleration will exceed the output ability of the vehicle at a current gear ratio, downshift is decided. In contrast, if the output ability of the vehicle at a gear ratio resulting from upshift is large enough to sustain the vehicle speed or to meet the acceleration request, upshift is decided. Compared with a case where an output obtained by subtracting a reserve capacity, with which the number of revolutions of the driving source is increased, is adopted as a reference, since the reverse capacity is not left, a gear ratio resulting from upshift is likely to be selected. Improvement in fuel consumption can be achieved.

Specifically, in the present invention (see, for example, FIG. 26 to FIG. 29),

the downshift decision means (51) may adopt as the second value (n_MAXpwr·E/G_reserved_pwr) an output obtained by subtracting a reserve capacity (E/G_reserved_pwr), with which the number of revolutions of the driving source (2) can be increased, from the current gear ratio maximum output (n_MAXpwr); and

the upshift decision means (52) may adopt as the fourth value (n+_MAXpwr·E/G_reserved_pwr) an output obtained by subtracting the reserve capacity from the post-upshift maximum output (n+_MAXpwr).

Thus, the output obtained by subtracting the reserve capacity, with which the number of revolutions of the driving source can be increased, from the current gear ratio maximum output may be adopted as the second value serving as a reference for deciding downshift. The output obtained by subtracting the reserve capacity, with which the number of revolutions of the driving source can be increased, from the post-upshift maximum output may be adopted as the fourth value. Therefore, if a vehicle speed is not sustained any longer because the sustention will exceed the output ability of a vehicle at a current gear ratio, or if acceleration is requested although the acceleration will exceed the output ability of the vehicle at a current gear ratio, downshift is decided. In contrast, if the output ability of the vehicle at a gear ratio resulting from upshift is large enough to sustain the vehicle speed or to meet the acceleration request, upshift is decided. Since the output obtained by subtracting the reserve capacity with which the number of revolutions of the driving source can be increased is used as a reference, the present invention is preferably adapted to a vehicle having, for example, a continuously variable transmission mounted therein, or a vehicle in which the driving source increases the number of revolutions thereof by itself at the time of gear shifting.

In addition, the present invention (see, for example, FIG. 4) may include a running resistance calculation means (23) capable of calculating the running resistance (roadR) occasionally.

Since the running resistance calculation means capable of calculating the running resistance occasionally is included, precision in selecting a gear ratio through computation is upgraded. Therefore, further improvement in fuel consumption can be achieved.

Further, in the present invention (see, for example, FIG. 4, FIG. 7, and FIG. 8), the request output calculation means (32) may calculate the requested request output (req_pwr) on the basis of a driving operation (for example, 71).

Thus, the request output calculation means calculates the requested request output on the basis of a driving operation, and enables selection of a gear ratio responsive to a driver's acceleration request.

In the present invention (see, for example, FIG. 4, FIG. 7, and FIG. 8),

the system may further include a vehicle speed sustention control means (60) that can control a vehicle speed so that the vehicle speed will be retained at a designated target vehicle speed; and

the request output calculation means (32) calculates the request output (req_pwr) requested by the vehicle speed sustention control means (60) as an output needed to accelerate a vehicle until the vehicle speed reaches the target vehicle speed.

Since the request output calculation means calculates the request output requested by the vehicle speed sustention control means as an output needed to accelerate a vehicle until the vehicle speed reaches the target vehicle speed, when control is executed to sustain the vehicle speed of the vehicle, not only the vehicle speed is sustained but also selection of a gear ratio needed to accelerate the vehicle swiftly until the vehicle speed reaches the target vehicle speed is enabled.

Further, in the present invention (see, for example, FIG. 4, FIG. 6, FIG. 17, and FIG. 18), the system may further include a post-downshift maximum output calculation means (42) which calculates a post-downshift maximum output (n·_MAXpwr), which is a maximum output of a vehicle at a gear ratio resulting from downshift, on the basis of the maximum output (E/G_MAXpwr) of the driving source (2); and

if the post-downshift maximum output (n·_MAXpwr) is smaller than the current gear ratio maximum output (n_MAXpwr), the downshift decision means (51) inhibits decision of downshift.

Thus, if the post-downshift maximum output is smaller than the current gear ratio maximum output, the downshift decision means inhibits decision of downshift. Therefore, when downshift is succeeded by a decrease in power at the time of, for example, over-revolution or driving at a high altitude, unnecessary downshift can be avoided.

Incidentally, symbols in parentheses are used to collate the description with drawings. The symbols are assigned for a better understanding of the present invention but will not affect Claims at all.

### BRIEF DESCRIPTION OF THE DRAWINGS

FIG. 1 is a skeleton diagram showing an automatic transmission to which the present invention is applicable;

FIG. 2 is a table concerning engagements made in an automatic speed changing mechanism;

FIG. 3 is a diagram indicating speeds attained by the automatic speed changing mechanism;

FIG. 4 is a block diagram showing a control system for an automatic transmission in accordance with the present invention;

FIG. 5 is a block diagram showing how to calculate a balance power;

FIG. 6 is a block diagram showing how to calculate a maximum power;

FIG. 7 is a block diagram showing how to calculate a request power;

FIG. 8 is a flowchart describing calculation of the request power;

FIG. 9 is a block diagram showing how to calculate a reserve quantity in accordance with the first embodiment;

FIGS. 10A and 10B show timing charts showing the relationship between a quick response filter and a slow response filter, wherein FIG. 10A is a timing chart indicating a request excess quantity, a quick response value, and a slow response value, and FIG. 10B is a timing chart indicating a reserve quantity obtained when a maximum value is selected;

FIG. 11 is a timing chart indicating an example of running achieved according to a reserve quantity designation technique in accordance with the first embodiment;

FIG. 12 is a timing chart for use in explaining a request excess quantity;

FIG. 13 is a timing chart for use in explaining the relationship between the request excess quantity and the reserve quantity;

FIG. 14 is a timing chart for use in explaining the relationship between a short-term request excess quantity and the reserve quantity;

FIGS. 15A and 15B show timing charts for use in explaining the relationship between the reserve quantity and a speed stage, wherein FIG. 15A is a timing chart concerned with a case where the reserve quantity is too small, and FIG. 15B is a timing chart concerned with a case where the reserve quantity is appropriate;

FIGS. 16A and 16B show timing charts for use in explaining the relationship between the reserve quantity and speed stage, wherein FIG. 16A is a timing chart concerned with a case where the reserve quantity is too large, and FIG. 16B is a timing chart concerned with a case where the reserve quantity is appropriate;

FIG. 17 is a block diagram showing how to perform calculation for deciding downshift;

FIG. 18 is a flowchart describing the calculation for deciding downshift;

FIG. 19 is a block diagram showing how to perform calculation for deciding upshift;

FIG. 20 is a flowchart describing the calculation for deciding upshift;

FIG. 21 shows shift points to be employed with an accelerator pedal released according to the first embodiment;

FIG. 22 shows shift points to be employed with the accelerator pedal depressed according to the first embodiment;

FIGS. 23A to 23D show timing charts showing an example of running to be achieved through gear shifting control in accordance with the present invention, wherein FIG. 23A is a timing chart indicating a running resistance, FIG. 23B is a timing chart indicating a vehicle speed, FIG. 23C is a timing chart indicating a speed stage, and FIG. 23D is a timing chart indicating an accelerator pedal angle;

FIGS. 24A to 24D show timing charts indicating an example of running to be achieved through gear shifting control based on shift maps according to the related art, wherein FIG. 24A is a timing chart indicating a running resistance, FIG. 24B is a timing chart indicating a vehicle speed, FIG. 24C is a timing chart indicating a speed stage, and FIG. 24D is a timing chart indicating an accelerator pedal angle;

FIGS. 25A to 25D show timing charts indicating an example of running to be achieved through gear shifting control based on shift maps modified in order to improve fuel consumption, wherein FIG. 25A is a timing chart indicating a running resistance, FIG. 25B is a timing chart indicating a vehicle speed, FIG. 25C is a timing chart indicating a speed stage, and FIG. 25D is a timing chart indicating an accelerator pedal angle;

FIG. 26 is a diagram indicating shift points to be employed with an accelerator pedal released according to a second embodiment;

FIG. 27 is a diagram indicating shift points to be employed with the accelerator pedal depressed according to the second embodiment;

FIG. 28 is a diagram indicating shift points to be employed with an accelerator pedal released according to a third embodiment;

FIG. 29 is a diagram indicating shift points to be employed with the accelerator pedal depressed according to the third embodiment;

FIG. 30 is a block diagram showing how to calculate a reserve quantity according to a fourth embodiment; and

FIG. 31 is a timing chart indicating an example of running to be achieved according to a reserve quantity designation technique in accordance with the fourth embodiment.

### DESCRIPTION OF PREFERRED EMBODIMENTS

Referring to the drawings, embodiments of the present invention will be described below.

(Outline Constitution of an Automatic Transmission)

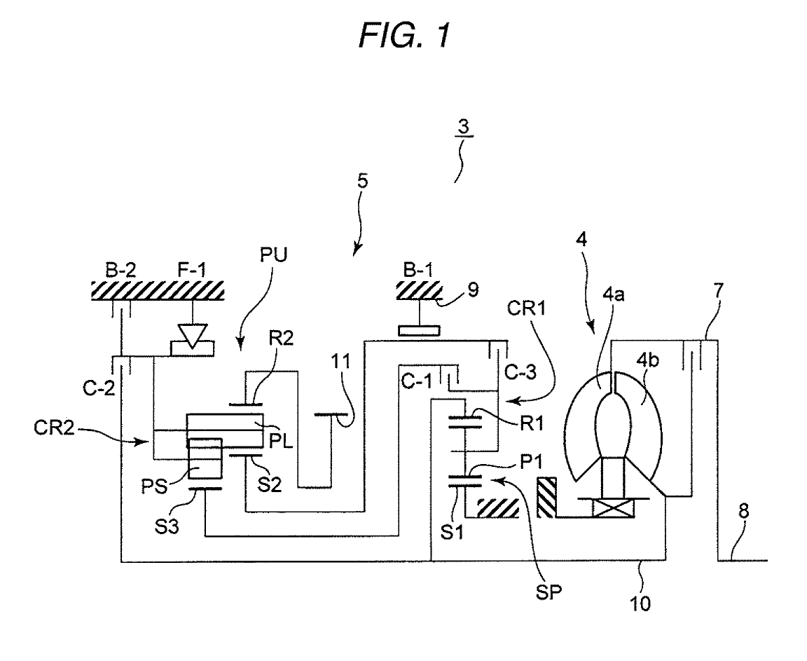

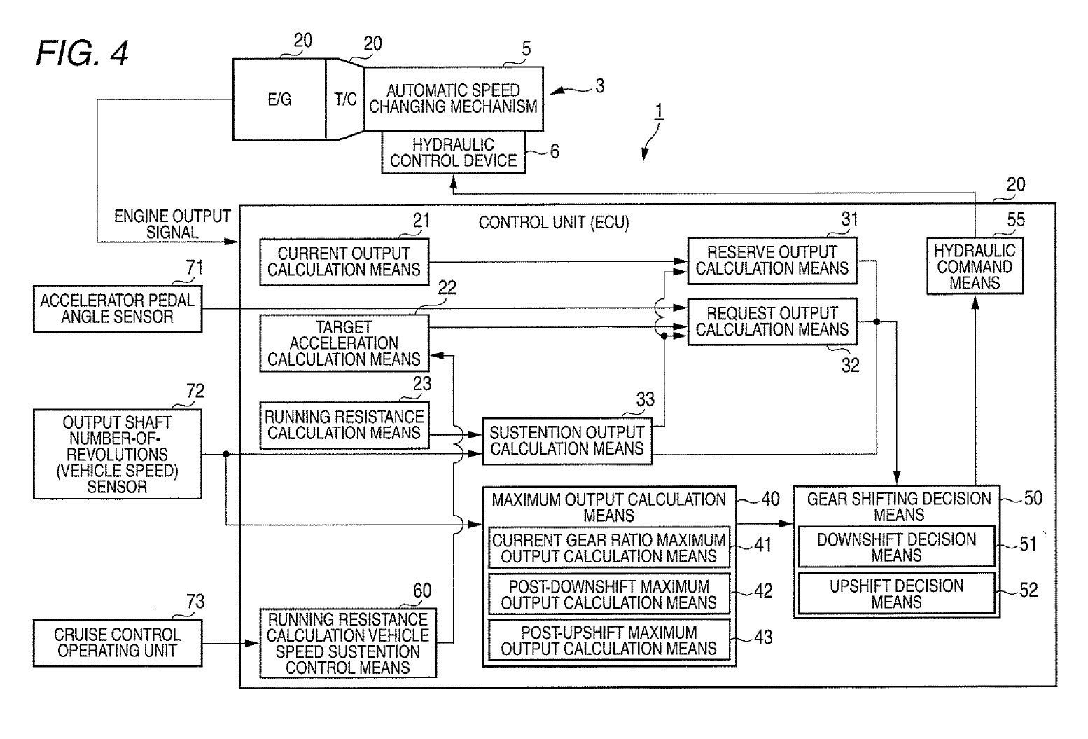

To begin with, the outline constitution of an automatic transmission 3 to which the present invention can be adapted will be described in conjunction with FIG. 1. As shown in FIG. 1, the automatic transmission 3 preferably employed in, for example, a front-engine front-drive (FF) type vehicle includes an automatic transmission input shaft 8 capable of being coupled to an engine (driving source) 2 (see FIG. 4), and includes a torque converter 4 and an automatic speed changing mechanism 5 with the axial direction of the input shaft 8 as a center.

The torque converter 4 includes a pump impeller 4a coupled to the input shaft 8 of the automatic transmission 3, and a turbine runner 4b to which the revolutions of the pump impeller 4a are transmitted via a working fluid. The turbine runner 4b is coupled to an input shaft 10 of the automatic speed changing mechanism 5 which is coaxial with the input shaft 8. The torque converter 4 is provided with a lockup clutch 7. When the lockup clutch 7 is engaged, the revolutions of the input shaft 8 of the automatic transmission 3 are transmitted directly to the input shaft 10 of the automatic speed changing mechanism 5.

The automatic speed changing mechanism 5 has a planetary gear train SP and a planetary gear unit PU disposed on the input shaft 10 thereof. The planetary gear train SP includes a sun gear S1, a carrier CR1, and a ring gear R1. The planetary gear train SP is a so-called single-pinion planetary gear train having the carrier CR1 provided with a pinion P1 that meshes with the sun gear S1 and ring gear R1.

The planetary gear unit PU includes as four revolutionary elements a sun gear S2, a sun gear S3, a carrier CR2, and a ring gear R2. The planetary gear unit PU is a so-called Ravigneaux type planetary gear unit having a long pinion PL, which meshes with the sun gear S2 and ring gear R2, and a short pinion PS, which meshes with the sun gear 53, disposed on the carrier CR2 thereof so that the long pinion and short pinion will mesh with each other.

The sun gear S1 included in the planetary gear train SP is connected to a boss, which is not shown and is fixed to a transmission case 9 as an integral part thereof, and has the revolutions thereof ceased. The ring gear R1 revolves along with the revolutions of the input shaft 10 (hereinafter, input revolutions). The carrier CR1 receives decelerated input revolutions, or in other words, has the revolutions thereof decelerated due to the fixed sun gear S1 and the ring gear R1 that revolves at the input revolution, and is connected to a clutch C-1 and a clutch C-3.

The sun gear 52 included in the planetary gear unit PU is connected to a brake B-1 realized with a band brake, and is freely fixed to the transmission case. In addition, the sun gear 52 is connected to the clutch C-3, and freely inputs the decelerated revolutions of the carrier CR1 via the clutch C-3. The sun gear S3 is connected to the clutch C-1, and freely inputs the decelerated revolutions of the carrier CR1.

Further, the carrier CR2 is connected to the clutch C-2 that inputs the revolutions of the input shaft 10, and freely inputs the input revolutions via the clutch C-2. In addition, the carrier CR2 is connected to a one-way clutch F-1 and a brake B-2, has the revolutions thereof restricted in one direction with respect to the transmission case via the one-way clutch F-1, and has the revolutions thereof freely ceased via the brake B-2. The ring gear R2 is connected to a counter gear (output shaft) 11. The counter gear 11 is connected to driving wheels via a counter shaft and a differential which are not shown.

(Movements in the Automatic Transmission in Each Speed Stage)

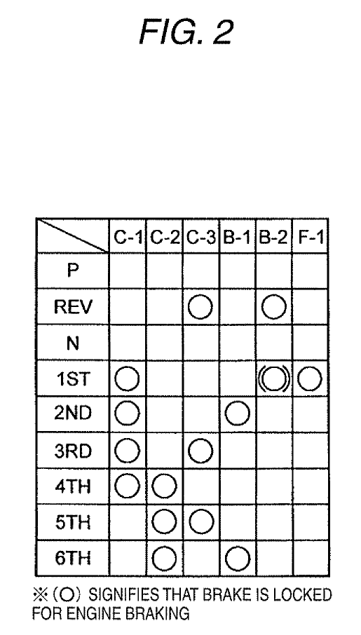

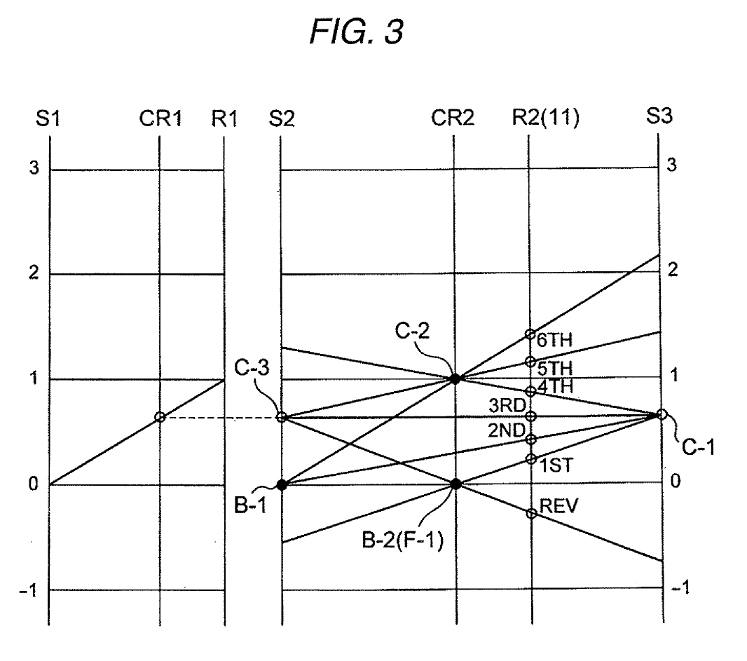

Based on the foregoing constitution, the operation of the automatic transmission 5 will be described below in conjunction with FIG. 1, FIG. 2, and FIG. 3. Ina speed diagram of FIG. 3, the direction of axes of ordinates indicates the number of revolutions of each of revolutionary elements (gears), and the direction of axes of abscissas indicates a gear ratio of each of the revolutionary elements. In part of the speed diagram relating to the planetary gear train SP, the axes of ordinates are associated with the sun gear S1, carrier CR1, and ring gear R1 in that order from the left-hand side of FIG. 3. In part of the speed diagram relating to the planetary gear unit PU, the axes of ordinates are associated with the sun gear S3, ring gear R2, and carrier CR2, and sun gear S2 in that order from the right-hand side of FIG. 3.

For example, when a first speed (1ST) stage for advancement in a drive (D) range is designated, the clutch C-1 and one-way clutch F-1 are engaged as shown in FIG. 2. Accordingly, as shown in FIG. 1 and FIG. 3, the decelerated revolutions of the carrier CR1 caused by the fixed sun gear S1 and the ring gear R1 that revolves at the input revolution are inputted to the sun gear 53 via the clutch C-1. In addition, the revolutions of the carrier CR2 are restricted to one direction (the direction of forward revolutions). In other words, the reverse revolutions of the carrier CR2 are prevented and ceased. This causes the decelerated revolutions, which are inputted to the sun gear 53, to be outputted to the ring gear R2 via the fixed carrier CR2. Eventually, forward revolutions in the first speed stage for advancement are outputted from the counter gear 11.

When an engine brake (coasting) is designated, the brake B-2 is locked, and the carrier CR2 is fixed in order to prevent the forward revolutions of the carrier CR2. Thus, the state attained in the first speed stage for advancement is sustained. In the first speed stage for advancement, the reverse revolutions of the carrier CR2 are prevented by the one-way clutch F-1, and the forward revolutions thereof are enabled. For example, after a non-running range is switched to a running range, the first speed stage for advancement can be smoothly attained through automatic engagement of the one-way clutch F-1.

In a second speed stage (2ND) for advancement, as shown in FIG. 2, the clutch C-1 is engaged and the brake B-1 is locked. Accordingly, as shown in FIG. 1 and FIG. 3, the decelerated revolutions of the carrier CR1 caused by the fixed sun gear S1 and the ring gear R1 that revolves at the input revolution are inputted to the sun gear S3 via the clutch C-1. In addition, since the brake B-1 is locked, the revolutions of the sun gear S2 are ceased. This causes the carrier CR2 to make decelerated revolutions at a lower speed than the sun gear 53 does. The decelerated revolutions inputted to the sun gear S3 are outputted to the ring gear R2 via the carrier CR2. Eventually, forward revolutions to be made in the second speed stage for advancement are outputted from the counter gear 11.

In a third speed stage (3RD) for advancement, as shown in FIG. 2, the clutch C-1 and clutch C-3 are engaged. Accordingly, as shown in FIG. 1 and FIG. 3, the decelerated revolutions of the carrier CR1 caused by the fixed sun gear S1 and the ring gear R1 that revolves at the input revolution are inputted to the sun gear 53 via the clutch C-1. In addition, the decelerated revolutions of the carrier CR1 are inputted to the sun gear S2 due to the engagement of the clutch C-3. Specifically, since the decelerated revolutions of the carrier CR1 are inputted to the sun gear 52 and sun gear 53, the planetary gear unit PU is directly connected to output the decelerated revolutions. The decelerated revolutions are outputted to the ring gear R2 as they are. Eventually, forward revolutions to be made in the third speed stage for advancement are outputted from the counter gear 11.

In a fourth speed stage (4TH) for advancement, as shown in FIG. 2, the clutch C-1 and clutch C-2 are engaged. Accordingly, as shown in FIG. 1 and FIG. 3, the decelerated revolutions of the carrier CR1 caused by the fixed sun gear S1 and the ring gear R1 that revolves at the input revolution are inputted to the sun gear S3 via the clutch C-1. In addition, the input revolutions are inputted to the carrier CR2 due to the engagement of the clutch C-2. Owing to the decelerated revolutions inputted to the sun gear S3 and the input revolutions inputted to the carrier CR2, decelerated rotations to be made at a higher speed than those in the third speed stage for advancement are outputted to the ring gear R2. Eventually, forward revolutions to be made in the fourth speed stage for advancement are outputted from the counter gear 11.

In a fifth speed stage (5TH) for advancement, as shown in FIG. 2, the clutch C-2 and clutch C-3 are engaged. Accordingly, as shown in FIG. 1 and FIG. 3, the decelerated revolutions of the carrier CR1 caused by the fixed sun gear 81 and the ring gear R1 that revolves at the input revolution are inputted to the sun gear S3 via the clutch C-3. In addition, the input revolutions are inputted to the carrier CR2 due to the engagement of the clutch C-2. Owing to the decelerated revolutions inputted to the sun gear 82 and the input revolutions inputted to the carrier CR2, revolutions to be made at a slightly higher speed than the input revolutions are outputted to the ring gear R2. Eventually, forward revolutions to be made in the fifth speed stage for advancement are outputted from the counter gear 11.

In a sixth speed stage (6TH) for advancement, as shown in FIG. 2, the clutch C-2 is engaged and the brake B-1 is locked. Accordingly, as shown in FIG. 1 and FIG. 3, the input revolutions are inputted to the carrier CR2 due to the engagement of the clutch C-2. In addition, the revolutions of the sun gear S2 are ceased due to the locking of the brake B-1. The input revolutions of the carrier C2 are changed to revolutions, which are made at a higher speed than those to be made in the fifth speed stage for advancement, by the fixed sun gear S2, and outputted to the ring gear R2. Eventually, forward revolutions to be made in the sixth speed stage for advancement are outputted from the counter gear 11.

In a first speed stage for reverse (REV), as shown in FIG. 2, the clutch C-3 is engaged and the brake B-2 is locked. Accordingly, as shown in FIG. 1 and FIG. 3, the decelerated revolutions of the carrier CR1 caused by the fixed sun gear S1 and the ring gear R1 that revolves at the input revolution are inputted to the sun gear S2 via the clutch C-1. In addition, the revolutions of the carrier CR2 are ceased due to the locking of the brake B-2. This causes the decelerated revolutions, which are inputted to the sun gear 52, to be outputted to the ring gear R2 via the fixed carrier CR2. Eventually, reverse revolutions to be made in the first speed stage for reverse are outputted from the counter gear 11.

Incidentally, for example, in a parking (P) range and a neutral (N) range, the clutch C-1, clutch C-2, and clutch C-3 are disengaged. Accordingly, the carrier CR1, sun gear S2, and sun gear S3, that is, the planetary gear train SP and planetary gear unit PU are disengaged. The input shaft 10 and carrier CR2 are disconnected. Therefore, power transmission between the input shaft 10 and planetary gear unit PU is discontinued. Namely, power transmission between the input shaft 10 and counter gear 11 is discontinued.

(Outline Constitution of a Control System for an Automatic Transmission)

Referring to FIG. 4, the outline constitution of a control system 1 for an automatic transmission in accordance with the present invention will be described below.

As shown in FIG. 4, the control system 1 for an automatic transmission includes a control unit (electronic control unit (ECU)) 20. An accelerator pedal angle sensor 71, an output shaft number-of-revolutions (vehicle speed) sensor 72, and a cruise control operating unit 73 are connected to the control unit 20. The control unit 20 includes a current output calculation means 21, a target acceleration calculation means 22, a running resistance calculation means 23, a reserve output calculation means 31, a request output calculation means 32, a sustention output calculation means 33, a maximum output calculation means 40 including a current gear ratio maximum output calculation means 41, a post-downshift maximum output calculation means 42, and a post-upshift maximum output calculation means 43, a gear shifting decision means 50 including a downshift decision means 51 and an upshift decision means 52, a hydraulic command means 55 connected to a hydraulic control device 6, and a vehicle speed sustention control means 60.

The hydraulic control device 6 is provided with multiple linear solenoid valves (not shown) capable of regulating and outputting an oil pressure in response to an electronic command. Hydraulic servomotors (not shown) for the clutches C-1, C-2, and C-3 and the brakes B-1 and B-2 included in the automatic speed changing mechanism 5 are controlled to freely adjust engagement pressures, whereby the engagement or disengagement of the clutches and the locking or unlocking of the brakes are freely controlled. Namely, speed stages can be controlled to be freely switched.

(Description of Various Computations)

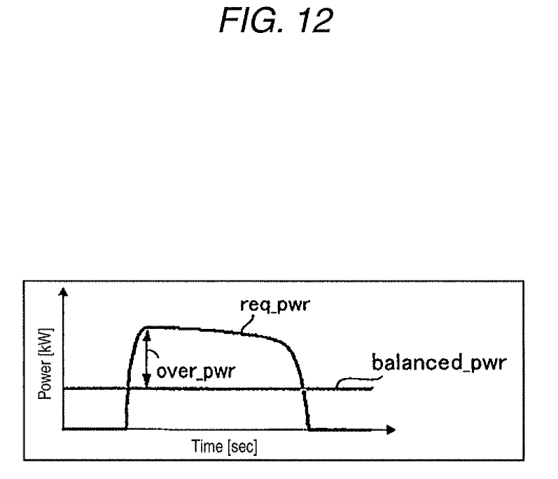

Computations to be performed by the pieces of means included in the control system 1 for an automatic transmission will be described in conjunction with FIG. 4 to FIG. 20. The computations to be performed by the pieces of means are repeated at intervals of, for example, several milliseconds with, for example, an ignition switch turned on or at least during running. Numerical values to be described below are calculated occasionally.

(Calculation of a Current Power)

The current output calculation means 21 calculates a power (current power), which is currently outputted from driving wheels, on the basis of an engine output signal inputted from the engine 2, a gear ratio between gears, which are connected to the engine and the driving wheels respectively, based on a current speed stage, and transmission efficiency. In the present embodiment, a value of an engine output is obtained based on an engine output signal sent from the engine in order to calculate the current power. Alternatively, for example, the current power may be calculated from the acceleration of a vehicle or the like. As long as the current power can be calculated, any way of calculation may be adopted, but the engine output signal may not be employed.

(Calculation of a Target Acceleration)

The vehicle speed sustention control means 60 is designed to sustain a driver-designated vehicle speed, that is, to execute so-called cruise control. For example, when the cruise control is executed along with a driver' s manipulative entry made on the cruise control operating unit 73, the vehicle speed sustention control means drives the throttle value or the like, which is not shown, so as to sustain the vehicle speed (target vehicle speed) which the driver has arbitrarily designated. At this time, for example, when a current vehicle speed is lower than a target vehicle speed, the target acceleration calculation means 22 calculates a target acceleration Aim_acc needed to cause the vehicle speed to reach the target vehicle speed in a predetermined time. When the cruise control is executed, the vehicle speed sustention control means 60 outputs a cruise signal. Cruise (sets a cruise signal flag) as detailed later.

(Calculation of a Running Resistance)

The running resistance calculation means 23 occasionally calculates a current running resistance roadR on the basis of an engine output signal, a gear ratio associated with a current speed stage, and the number of output revolutions outRpm to be detected by the output shaft number-of-revolutions (vehicle speed) sensor 72 (especially, a change in the number of output revolutions outRpm (a change in a revolving acceleration)), or in other words, on the basis of a current output (current power) of a vehicle and a change in the acceleration of the vehicle.

(Calculation of a Sustention Output (Balance Power))

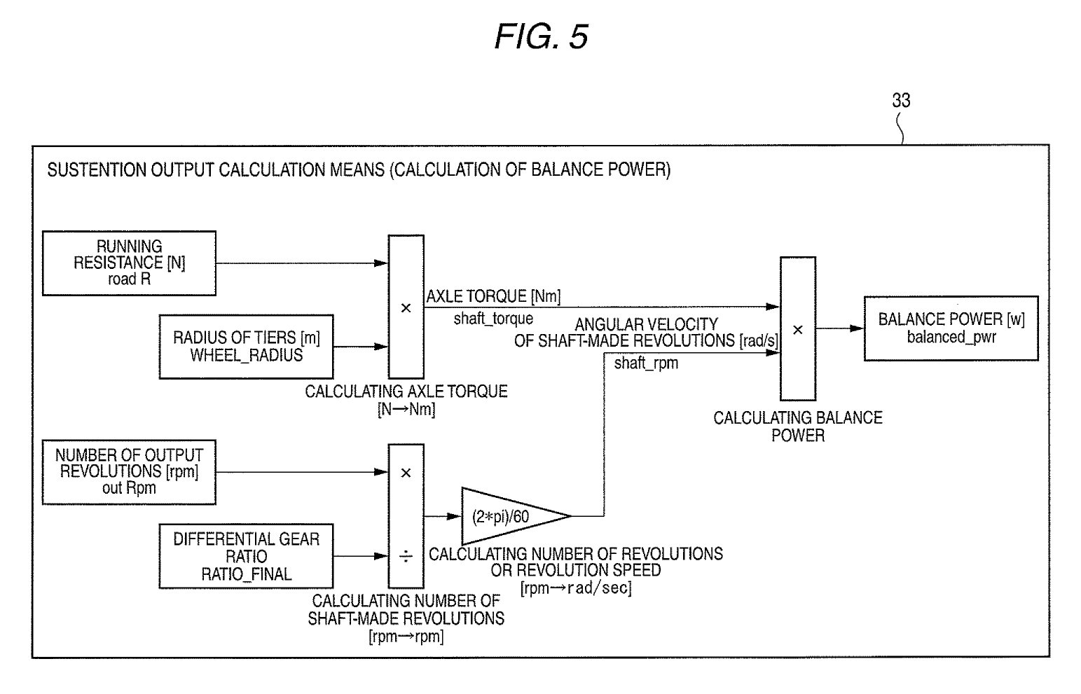

The sustention output calculation means 33 multiplies, as shown in FIG. 4 and FIG. 5, a running resistance roadR, which is occasionally calculated by the running resistance calculation means 23, by a radius of tires WHEEL_RADIUS so as to calculate an axle torque shaft_torque. The sustention output calculation means 33 divides the number of output revolutions outRpm, which is detected by the output shaft number-of-revolutions sensor 72, by a differential gear ratio RATIO_FINAL (a gear ratio in a differential gear) so as to calculate the number of shaft-made revolutions, and converts the number of shaft-made revolutions into an angular velocity of shaft revolutions shaft_rpm. The sustention output calculation means 33 then multiplies the axle torque shaft_torque by the angular velocity of shaft-made revolutions shaft_rpm so as to calculate a balance power balanced_pwr needed to sustain a vehicle speed (namely, balanced with the running resistance roadR).

(Calculation of a Maximum Output (Maximum Power))

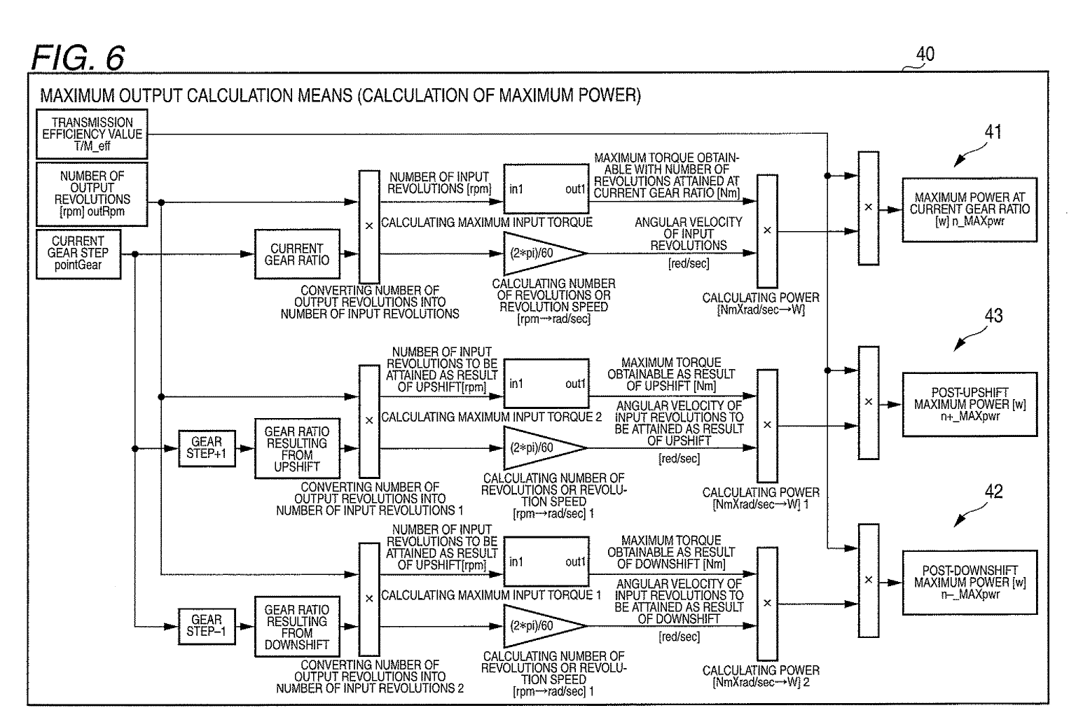

The maximum output calculation means 40 inputs, as shown in FIG. 4 and FIG. 6, an efficiency value T/M_eff relating to the transmission and being recorded in advance in the control unit 20, the number of output revolutions outRpm detected by the output shaft number-of-revolutions sensor 72, and a current gear step pointGear resulting from decision of gear shifting performed by the gear shifting decision means 50 to be described later. The current gear ratio maximum output calculation means 41 calculates a maximum power (current gear ratio maximum power) n_MAXpwr to be exerted by a vehicle at a current gear ratio. The post-downshift maximum output calculation means 42 calculates a maximum power (post-downshift maximum power) n·_MAXpwr to be exerted by the vehicle at a gear ratio resulting from downshift. The post-upshift maximum output calculation means 43 calculates a maximum power (post-upshift maximum power) n+_MAXpwr to be exerted by the vehicle at a gear ratio resulting from upshift.

To be more specific, the current gear ratio maximum output calculation means 41 multiplies the number of output revolutions outRpm by a current gear ratio based on a current gear step pointGear so as to calculate the number of input revolutions. Thereafter, the current gear ratio maximum output calculation means 41 calculates a maximum torque, which the engine 2 can output at the current number of revolutions, by referring a torque performance curve (not shown), which relates to the engine 2 and is recorded in advance in, for example, the control unit 20, on the basis of an engine speed into which the number of input revolutions is approximately fitted. The number of input revolutions is converted into an angular velocity of input revolutions. The angular velocity of input revolutions is multiplied by a maximum torque of the engine 2 in order to calculate a theoretical maximum input to be obtainable in a current running state (engine speed). The theoretical maximum input is multiplied by the transmission efficiency value T/M_eff in order to calculate a current gear ratio maximum power n_MAXpwr that is a theoretical maximum output to be obtainable in the current running state (engine speed).

The post-upshift maximum output calculation means 43 multiplies the number of output revolutions outRpm by a post-upshift gear ratio based on a gear step resulting from upshift (gear step+1) so as to calculate the number of input revolutions to be attained as a result of upshift. Thereafter, the post-upshift maximum output calculation means 43 calculates a maximum torque, which the engine 2 can output at the number of revolutions resulting from upshift, by referencing the torque performance curve (not shown), which relates to the engine 2, on the basis of an engine speed which is obtainable as a result of upshift and to which the number of input revolutions to be attained as a result of upshift is approximated. In addition, the number of input revolutions to be attained as a result of upshift is converted into an angular velocity of input revolutions to be attained as a result of upshift, and multiplied by a maximum torque of the engine 2, which is obtainable as a result of upshift, in order to calculate a theoretical maximum input obtainable in a running state (engine speed) to be attained as a result of upshift. The theoretical maximum input is multiplied by the transmission efficiency value T/M_eff in order to calculate a post-upshift maximum power n+_MAXpwr that is a theoretical maximum output obtainable in the running state (engine speed) to be attained as a result of upshift.

Likewise, the post-downshift maximum output calculation means 42 first multiplies the number of output revolutions outRpm by a gear ratio, which results from downshift and is based on a gear step (gear step−1) resulting from downshift, so as to calculate the number of input revolutions that can be obtained if downshift is achieved. The post-downshift maximum output calculation means 42 then calculates an engine speed to be attained as a result of downshift, and calculates a maximum torque which the engine 2 can output at the number of revolutions to be attained as a result of downshift. In addition, an angular velocity of input revolutions to be attained as a result of downshift is calculated and multiplied by a maximum torque, which is exerted by the engine 2 after downshift is achieved, in order to calculate a theoretical maximum input obtainable in a running state (engine speed) to be attained as a result of downshift. The theoretical maximum input is multiplied by the transmission efficiency value T/M_eff in order to calculate a post-downshift maximum power n·_MAXpwr that is a theoretical maximum output obtainable in the running state (engine speed) to be attained as a result of downshift.

(Calculation of a Request Output (Request Power))

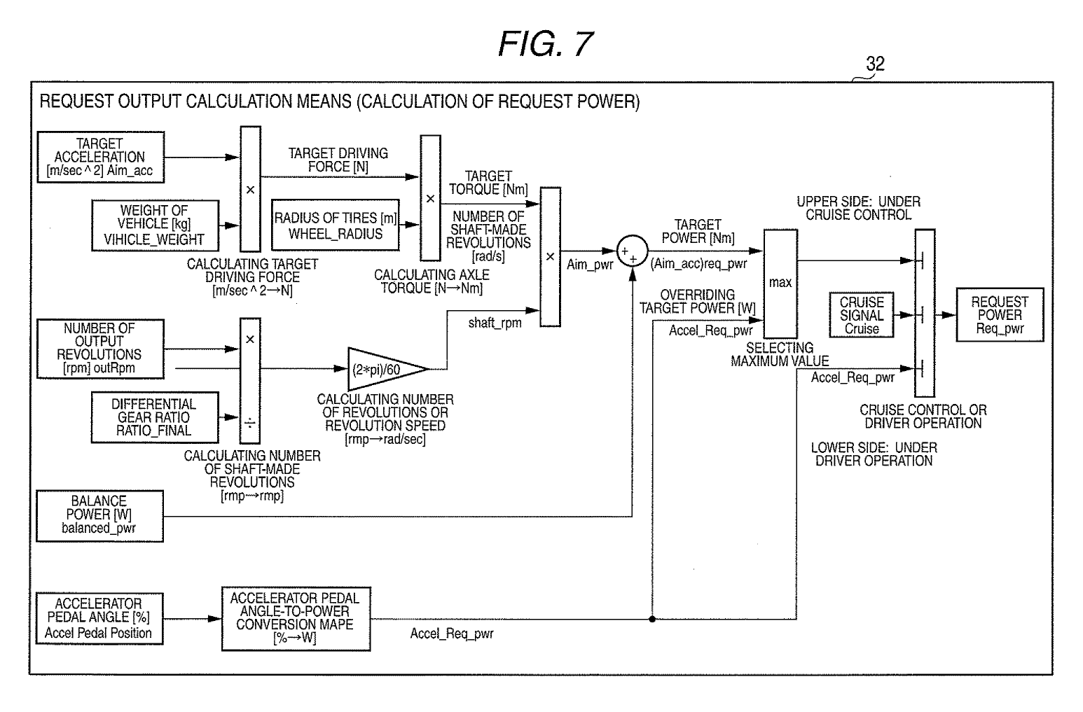

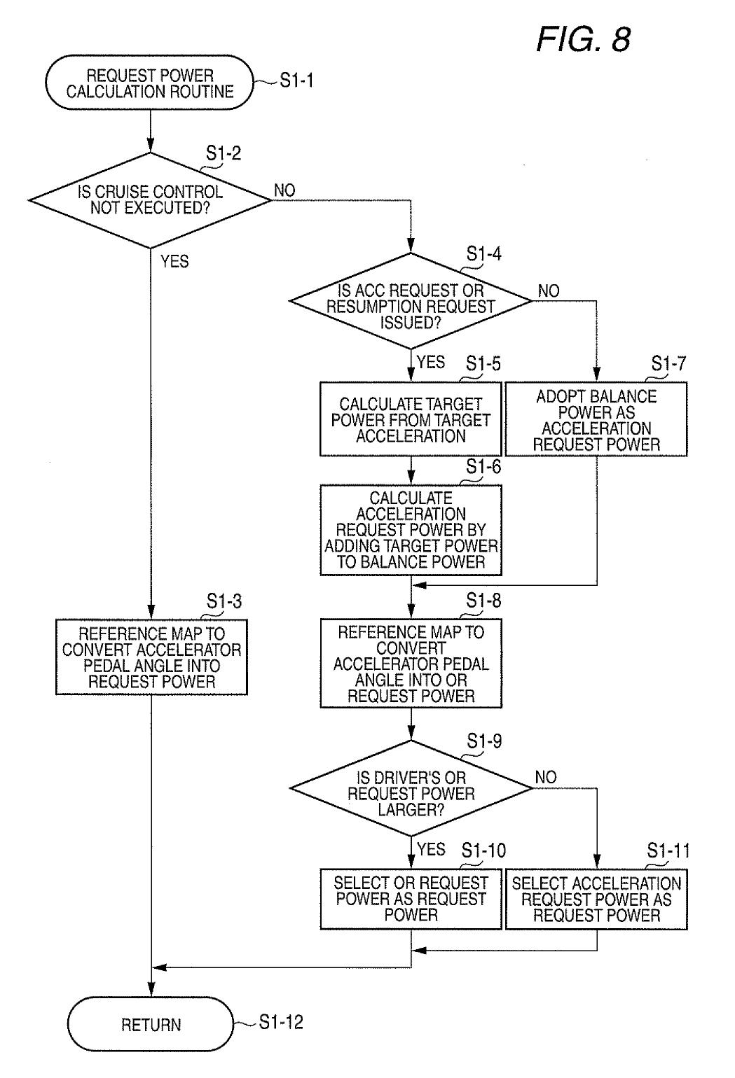

The request output calculation means 32 performs different computations between a case where a vehicle is normally run through a driver's driving operation (cruise control is not executed) and a case where cruise control is executed (in particular, an acceleration request is issued). Specifically, the request output calculation means 32 invokes a request power calculation routine described in FIG. 8 (S1-1). Assuming that the vehicle is normally run but cruise control is not executed by the vehicle speed sustention control means (a cruise signal is not outputted) (Yes at S1-2), an accelerator pedal angle θd detected by the accelerator pedal angle sensor 71 is inputted as shown in FIG. 4 and FIG. 7. A shift map of accelerator pedal angles vs. powers (not shown) in which the computed relationships between accelerator pedal angles and powers are recorded and which is stored in the control unit 20 in advance is referenced in order to retrieve a request power req_pwr associated with an action performed on the accelerator pedal (S1-3). During normal running, the computation is repeated occasionally (S1-12).

As described in FIG. 8, if cruise control is being executed by the vehicle speed sustention control means 60 (No at S1-2), whether an acceleration (ACC) request (at the cruise control operating unit) or a resumption request (a request for restoring a designated vehicle speed after a vehicle is temporarily decelerated) has been made is decided (S1-4). If neither of the requests is made (No at S1-4), that is, if the vehicle is run with the vehicle speed sustained through cruise control, a balance power balanced_pwr calculated by the running resistance calculation means 23 is, as seen from FIG. 4 and FIG. 7, adopted as a target power (Aim_acc)req_pwr as it is (S1-7).

As described in FIG. 8, if the ACC request or resumption request is issued during cruise control (Yes at S1-4), the request output calculation means 32 multiplies the target acceleration Aim_acc, which is calculated by the target acceleration calculation means 22, by the weight of the vehicle VEHICLE_WEIGHT so as to calculate a target driving force, and multiplies the target driving force by the radius of tires WHEEL_RADIUS so as to calculate a target torque. Further, the number of output revolutions outRpm detected by the output shaft number-of-revolutions sensor 72 is divided by the differential gear ratio RATIO_FINAL (the gear ratio in the differential gear) in order to calculate the number of shaft-made revolutions. The number of shaft-made revolutions is converted into an angular velocity of shaft-made revolutions shaft_rpm. The target torque is multiplied by the angular velocity of shaft-made revolutions shaft_rpm in order to calculate a target power needed for acceleration (S1-5). Further, the balance power balanced_pwr is added to the target power in order to calculate a target power (Aim_acc)req_pwr for the vehicle (S1-6).

After calculating the target power (Aim_acc)req_pwr needed under cruise control as mentioned above (S1-4 to S1-7), the request output calculation means 32 proceeds to step S1-8 in FIG. 8, calculates, as shown in FIG. 7, an overriding target power (OR request power), that is, a request power Accel_req_pwr based on an action performed on the accelerator pedal, and decides whichever of the target power (Aim_acc)req_pwr and overriding target power Accel_req_pwr is larger (S1-9). If the overriding target power Accel_req_pwr is larger, the overriding target power is adopted as the request power req_pwr (S1-10). If the target power (Aim_acc)req_pwr needed under cruise control is larger, the target power is adopted as the request power req_pwr (S1-11). When cruise control is executed, the above computation is occasionally repeated (S1-12).

(Calculation for Deciding Gear Shifting)

Referring to FIG. 4 and FIG. 17 to FIG. 22, calculation for deciding gear shifting (computation method) that is a constituent feature of the present invention will be described below. In a computation method for deciding gear shifting in accordance with the present embodiment, the value of a reserve power reserved_pwr greatly affects the fuel consumption of a vehicle, the drivability thereof or the like. A calculation method for the reserve power reserved_pwr relates to a calculation method for deciding gear shifting. Therefore, the calculation method for deciding gear shifting will be described first.

(Calculation for Deciding Downshift)

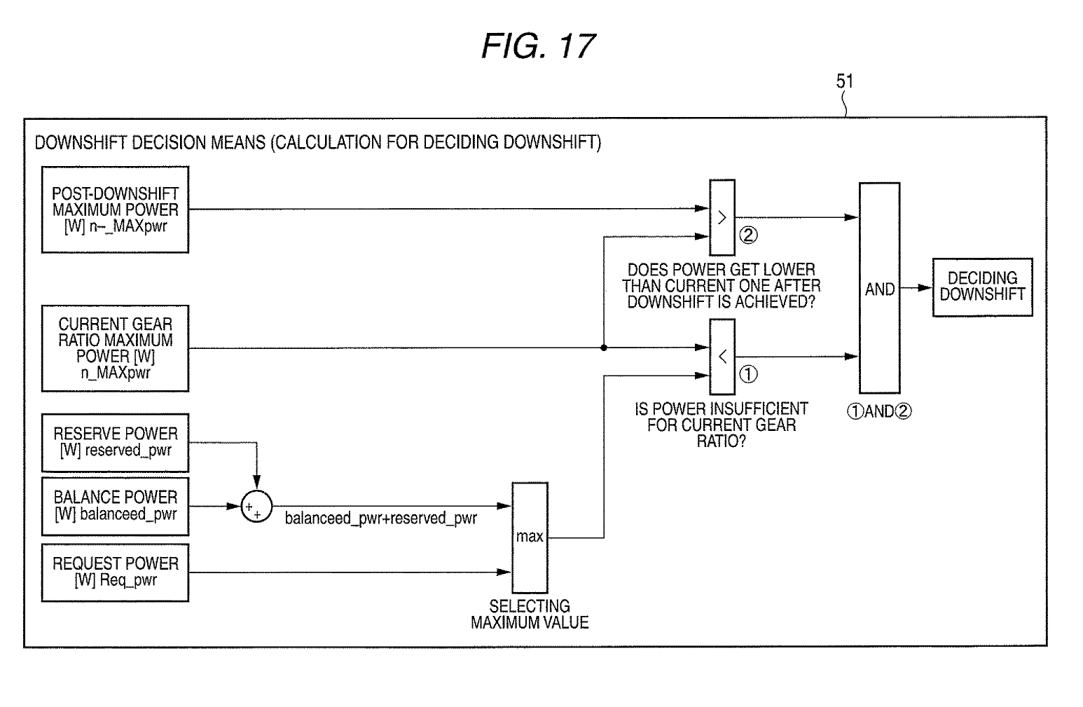

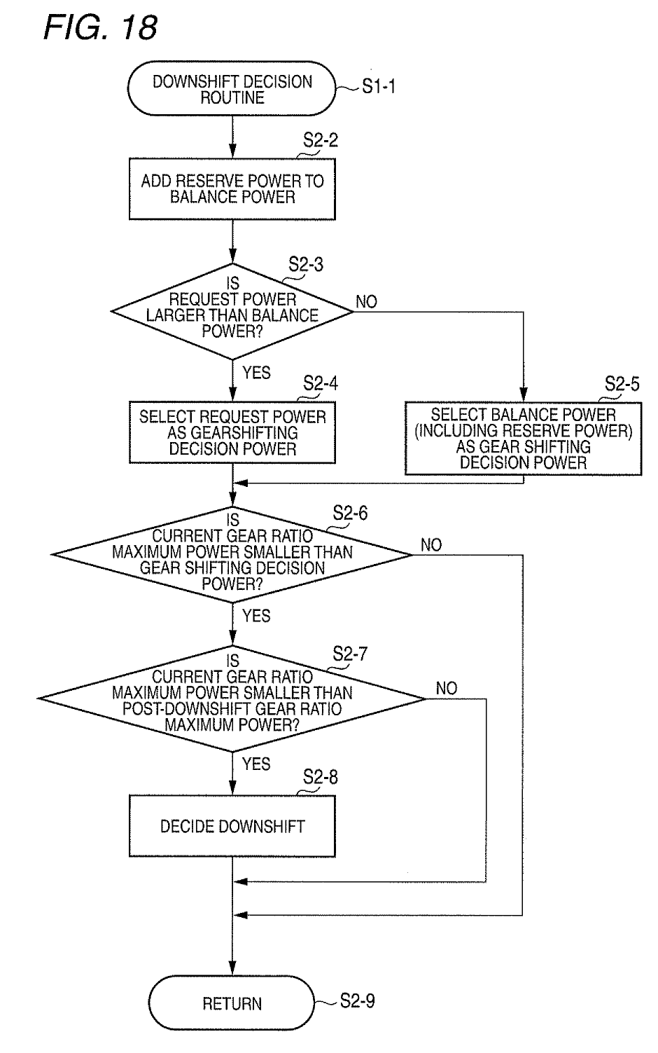

When a downshift decision routine described in FIG. 18 is invoked (S2-1), the downshift decision means 51 adds a reserve power reserved_pwr, which is calculated by the reserve output calculation means 31 to be described later, to the balance power balanced_pwr calculated by the sustention output calculation means 33 (S2-2), as shown in FIG. 17. Thereafter, the downshift decision means 51 decides whichever of the value obtained by adding the reserve power reserved_pwr to the balance power balanced_pwr and the request power req_pwr calculated by the request output calculation means 32 as described above is larger (S2-3). If the request power req_pwr is larger (Yes at S2-3), the value is selected as a gear shifting decision power (second value) (S2-4). If the value obtained by adding the reserve power reserved_pwr to the balance power balanced_pwr is larger (No at S2-3), the value is selected as the gear shifting decision power (second value) (S2-5).

After selecting the gear shifting decision power as mentioned above, the downshift decision means 51 decides whether the gear shifting decision power is larger than the current gear ratio maximum power n_MAXpwr calculated by the current gear ratio maximum output calculation means 41 (S2-6). If the gear shifting decision power is smaller than the current gear ratio maximum power n_MAXpwr, that is, the value obtained by adding the reserve power reserved_pwr to the balance power balanced_pwr or the request power req_pwr is smaller than the current gear ratio maximum power n_MAXpwr (No at S2-6), downshift is not decided but the same computation is repeated (s2-9).

If the gear shifting decision power is larger than the current gear ratio maximum power n_MAXpwr, that is, if the value obtained by adding the reserve power reserved_pwr to the balance power balanced_pwr or the request power req_pwr is larger than the current gear ratio maximum power n_MAXpwr (Yes at S2-6), processing fundamentally proceeds to step S2-8 in FIG. 18 and downshift is decided.

When the balance power balanced_pwr (including the reserve power reserved_pwr) is (gets) larger than the current gear ratio maximum power n_MAXpwr, even if, for example, a driver further steps on the accelerator pedal and the engine provides a maximum output with the current number of revolutions (with the throttle value fully opened), the maximum output is defeated by the running resistance roadR. The vehicle speed is not sustained. Therefore, downshift is decided.

When the request power req_pwr is (gets) larger than the current gear ratio maximum power n_MAXpwr, even if, for example, a vehicle is normally run (cruise control is not executed) and the engine 2 provides a maximum output with the current number of revolutions (with the throttle value fully opened), a driver-intended acceleration request is not met. Therefore, downshift is decided. Further, when, for example, cruise control is executed, even if the engine 2 provides the maximum output with the current number of revolutions (with the throttle value fully opened), a vehicle speed is not retained at a designated value or an ACC request or a resumption request is not met. Therefore, downshift is decided.

As mentioned above, calculation for deciding downshift is achieved by comparing a first value with a second value. In the first embodiment, the current gear ratio maximum power n_MAXpwr is adopted as the second value, and the larger one of the value obtained by adding the reserve power reserved_pwr to the balance power balanced_pwr and the request power req_pwr is adopted as the first value. The calculation for deciding downshift is expressed by a formula (1) below.

n_MAXpwr<MAX[(balanced_pwr+reserved_pwr),req_pwr] (1)

In the present embodiment, if a decision is made at step S2-6 in FIG. 18 that the gear shifting decision power is larger than the current gear ratio maximum power n_MAXpwr, whether the post-downshift maximum power n·_MAXpwr calculated by the post-downshift maximum output calculation means 42 is larger than the current gear ratio maximum power n_MAXpwr calculated by the current gear ratio maximum output calculation means 41 is decided. In other words, if an engine speed rises in a high-speed revolution region, in which over-revolution of the engine 2 occurs after downshift is achieved, or at a high altitude, an engine torque may greatly decrease or a power may get smaller than that at a current speed stage after downshift is achieved. In this case (No at S2-7), deciding downshift is prevented. If a power gets larger than that at the current speed stage after typical downshift is achieved (Yes at S2-7), deciding downshift (S2-8) is permitted.

If the downshift decision means 51 decides downshift as mentioned above, the hydraulic command means 55 outputs, as shown from FIG. 4, an electronic command to a linear solenoid valve (not shown) in the hydraulic control device 6 so as to execute downshift of the automatic transmission 3.

(Calculation for Deciding Upshift)

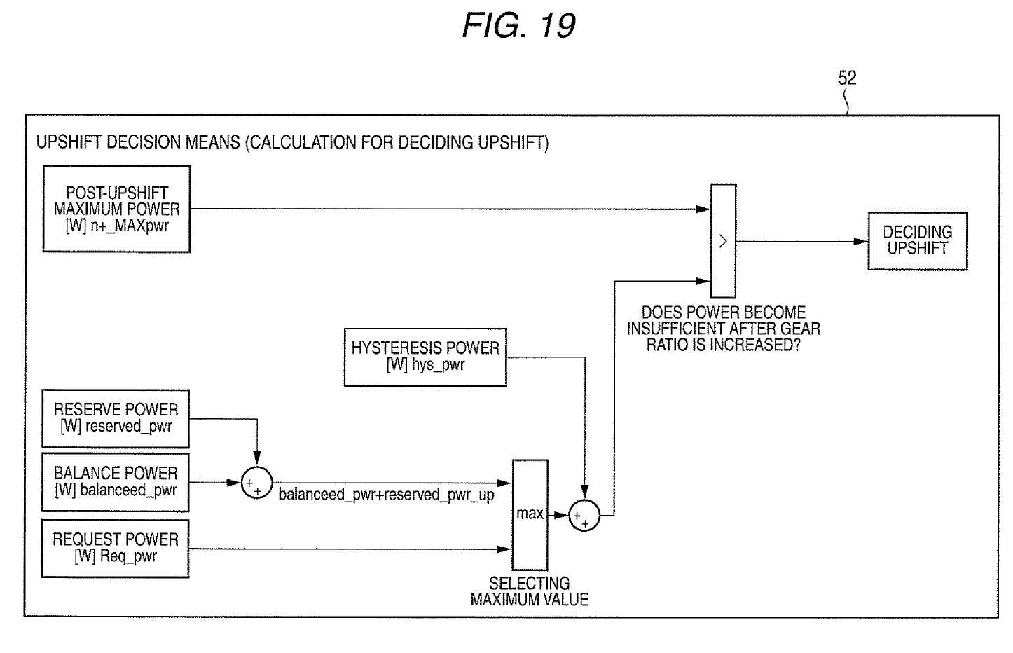

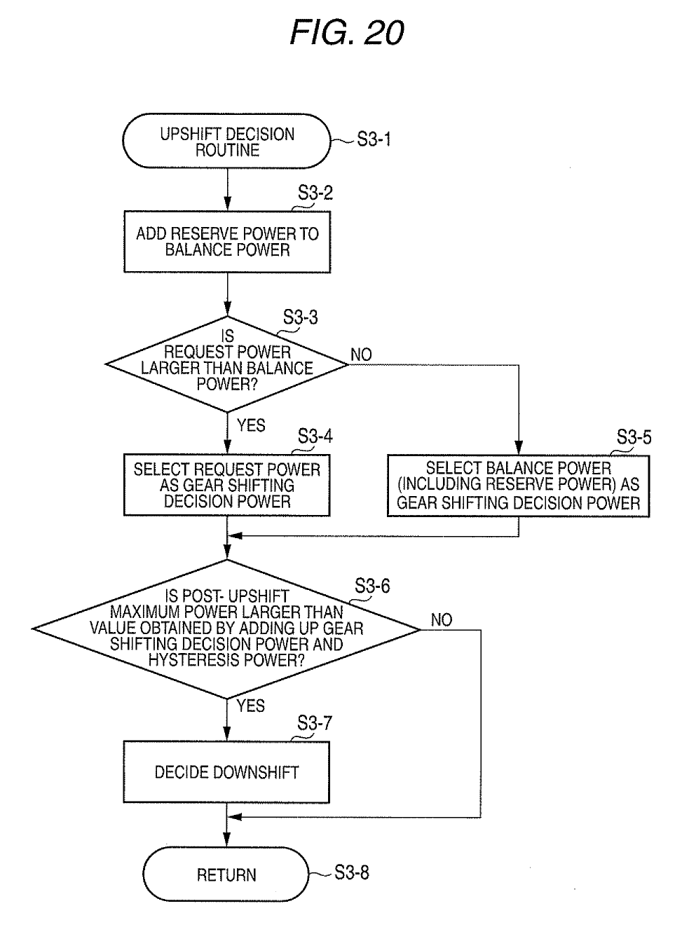

When an upshift decision routine described in FIG. 20 is invoked (S3-1), the upshift decision means 52 adds, as shown in FIG. 19, similarly to the case of deciding downshift, a reserve power reserved_pwr to a balance power balanced_pwr (S3-2), and decides whichever of the resultant value and a request power req_pwr is larger (S3-3). If the request power req_pwr is larger (Yes at S3-3), the value is selected as a gear shifting decision power (fourth value) (S3-4). If the value obtained by adding the reserve power reserved_pwr to the balance power balanced_pwr is larger (No at S3-3), the value is selected as the gear shifting decision power (fourth value) (S3-5).

After selecting the gear shifting decision power as mentioned above, the upshift decision means 52 adds a hysteresis power hys_pwr, which is used to prevent hunting for the downshift decision, to a value to be adopted when upshift is decided, to the gear shifting decision power, and decides whether a post-upshift maximum power n+_MAXpwr calculated by the post-upshift maximum output calculation means 43 is larger than the resultant value (S3-6). If the post-upshift maximum power n+_MAXpwr is smaller than the value obtained by adding the hysteresis power hys_pwr to the gear shifting decision power, that is, if the post-upshift maximum power n+_MAXpwr is smaller than the value obtained by adding the reserve power reserved_pwr and hysteresis power hys_pwr to the balance power balanced_pwr or the value obtained by adding the hysteresis power hys_pwr to the request power req_pwr (No at S2-6) upshift is not decided but the same computation is repeated (S3-8).

If the post-upshift maximum power n+_MAXpwr is larger than the value obtained by adding the hysteresis power hys_pwr to the gear shifting decision power, that is, if the post-upshift maximum power n+_MAXpwr is larger than the value obtained by adding the reserve power reserved_pwr and hysteresis power hys_pwr to the balance power balanced_pwr or the value obtained by adding the hysteresis power hys_pwr to the request power req_pwr (Yes at S2-6), processing proceeds to step S3-7 in FIG. 20 and upshift is decided.

Specifically, when the post-upshift maximum power n+_MAXpwr is (gets) larger than the balance power balanced_pwr (including the reserve power reserved_pwr and hysteresis power hys_pwr), even if, for example, upshift is achieved, a maximum output provided by the engine 2 that revolves at the current number of revolutions will not be defeated by the running resistance roadR. The vehicle speed can be sustained even after the upshift is achieved. Therefore, upshift is decided.

When the post-upshift maximum power n+_MAXpwr is (gets) larger than the request power req_pwr (including the hysteresis power hys_pwr), since, for example, a vehicle is normally run (cruise control is not executed), a driver-intended acceleration request can be met with the maximum output of the engine 2 that revolves at the number of revolutions resulting from upshift. Therefore, upshift is decided. Even when, for example, cruise control is executed, since a designated vehicle speed can be sustained with the maximum output of the engine 2 that revolves at the number of revolutions resulting from upshift, or an ACC request or a resumption request can be met, upshift is decided.

As mentioned above, calculation for deciding upshift is achieved by comparing the third value with the fourth value. In the first embodiment, the post-upshift maximum power n+_MAXpwr is adopted as the fourth value, and the value obtained by adding the hysteresis power hys_pwr to the larger one of the value, which is obtained by adding the reserve power reserved_pwr to the balance power balanced_pwr, and the request power req_pwr is adopted as the third value. The calculation for deciding upshift is expressed by a formula (2) below.

n+_MAXpwr>Max[(balanced_pwr+reserved_pwr),req_pwr]+hys_pwr (2)

The formula (2) is synonymous with a formula (2′) below.

n+_MAXpwr>Max[(balanced_pwr+reserved_pwr+hys_pwr),(req_pwr+hys_pwr)] (2′)

When the upshift decision means 52 decides upshift as described above, the hydraulic command means 55 outputs an electronic command to the linear solenoid valve (not shown) in the hydraulic control device 6 so that upshift of the automatic transmission 3 will be executed.

(Shift Points with the Accelerator Pedal Released)

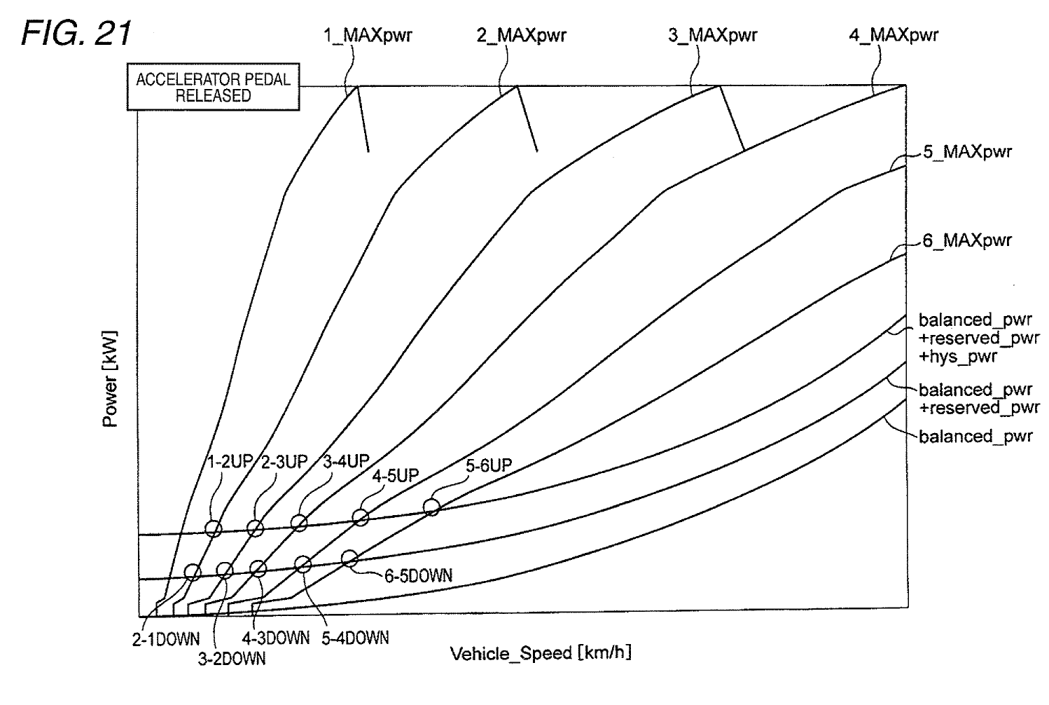

For the foregoing downshift decision and upshift decision, a shift point can be expressed with the relationship between a vehicle speed and a power. When the accelerator pedal is released, that is, in a case where a value obtained by adding the reserve power reserved_pwr to the balance power balanced_pwr is larger than the request power req_pwr (when the sum of the balance power balanced_pwr and reserve power reserved_pwr is selected as the gear shifting decision power), shift points can be expressed as shown in FIG. 21.

Talking of a maximum power to be transmitted based on a maximum output of the engine 2 from the automatic transmission 3, a maximum power 1_MAXpwr to be transmitted in the first speed stage for advancement, etc., and a maximum power 6_MAXpwr to be transmitted in the sixth speed stage for advancement are graphically shown in FIG. 21. Incidentally, a maximum power depending on a vehicle speed is uniquely calculated using a gear ratio on the basis of maximum performance associated with an engine speed. Even if downshift or upshift is carried out, the vehicle speed does not substantially change. As the current gear ratio maximum power n_MAXpwr is occasionally calculated, so the post-downshift maximum power n·_MAXpwr is occasionally calculated. The post-downshift maximum power n·_MAXpwr is a value plotted on an upper side in the direction of the axis of ordinates, and the post-upshift maximum power n+_MAXpwr that is also occasionally calculated is a value plotted on a lower side in the direction of the axis of ordinates.

The balance power balanced_pwr is, as mentioned above, an output needed to sustain a vehicle speed against the running resistance roadR. The running resistance roadR gets larger along with a rise in the vehicle speed due to a resistance of a road against a vehicle, an air resistance or the like the vehicle incurs. Therefore, as the vehicle speed rises, the balance power balanced_pwr increases. If an intersection between a curve indicating the balance power balanced_pwr and a curve indicating any of the maximum powers 1_MAXpwr to 6_MAXpwr in the first to sixth speed stages for advancement is regarded as a shift point, it means that a critical point at which the vehicle speed may or may not be sustained is regarded as the shift point. In this case, there is no tolerance. Even when a driver steps on the accelerator pedal to fully open the throttle valve, the vehicle speed can merely be sustained but the vehicle is not accelerated.

In the present embodiment, when a vehicle is normally run (run with cruise control not executed) and the accelerator pedal is released, the request power req_pwr calculated by the request output calculation means 32 is substantially 0. As expressed by the formula (1) for deciding downshift, the value obtained by adding the reserve power reserved_pwr to the balance power balanced_pwr is selected as the gear shifting decision power. An intersection between a curve indicating the value, which is obtained by adding the reserve power reserved_pwr to the balance power balanced_pwr, and a curve indicating any of the maximum powers 1_MAXpwr to 6_MAXpwr in the first to sixth speed stages for advancement is, as shown in FIG. 21, regarded as a downshift shift point.

For example, if it becomes impossible to output the value, which is obtained by adding the reserve power reserved_pwr to the balance power balanced_pwr, in terms of the maximum power 6_MAXpwr based on the maximum output of the engine 2 in the sixth speed stage for advancement, the sixth speed stage for advancement is shifted to the fifth speed stage for advancement (6-5DOWN). For example, if it becomes impossible to output the value, which is obtained by adding the reserve power reserved_pwr to the balance power balanced_pwr, in terms of the maximum power 5_MAXpwr based on the maximum output of the engine 2 in the fifth speed stage for advancement, the fifth speed stage for advancement is shifted to the fourth speed stage for advancement (5-4DOWN). For example, if it becomes impossible to output a value, which is obtained by adding the reserve power reserved_pwr to the balance power balanced_pwr, in terms of the maximum power 2_MAXpwr based on the maximum output of the engine 2 in the second speed stage for advancement, the second speed stage for advancement is shifted to the first speed stage for advancement (2-1DOWN).

As expressed by the formula (2) for deciding upshift, when the accelerator pedal is released, the value obtained by adding the reserve power reserved_pwr and hysteresis power hys_pwr to the balance power balanced_pwr is selected as the gear shifting decision power. In other words, an intersection between a curve indicating the value, which is obtained by adding the reserve power reserved_pwr and hysteresis power hys_pwr to the balance power balanced_pwr, and a curve indicating any of the maximum powers 1_MAXpwr to 6_MAXpwr in the first to sixth speed stages for advancement is, as shown in FIG. 21, regarded as an upshift shift point.

For example, when the first speed stage for advancement is designated, if it becomes possible to output the value obtained by adding the reserve power reserved_pwr and hysteresis power hys_pwr to the balance power balanced_pwr in terms of the maximum power 2_MAXpwr based on the maximum output of the engine 2 in the second speed stage resulting from upshift, the first speed stage for advancement is shifted to the second speed stage for advancement (1-2UP). For example, when the second speed stage for advancement is designated, if it becomes possible to output the value, which is obtained by adding the reserve power reserved_pwr and hysteresis power hys_pwr to the balance power balanced_pwr, in terms of the maximum power 3_MAXpwr based on the maximum output of the engine 2 in the third speed stage for advancement resulting from upshift, the second speed stage for advancement is shifted to the third speed stage for advancement (2-3UP) For example, when the fifth speed stage for advancement is designated, if it becomes possible to output the value, which is obtained by adding the reserve power reserved_pwr and hysteresis power hys_pwr to the balance power balanced_pwr, in terms of the maximum power 6_MAXpwr based on the maximum output of the engine 2 in the sixth speed stage for advancement resulting from upshift, the fifth speed stage for advancement is shifted to the sixth speed stage for advancement (5-6UP).

(Shift Points with the Accelerator Pedal Depressed)

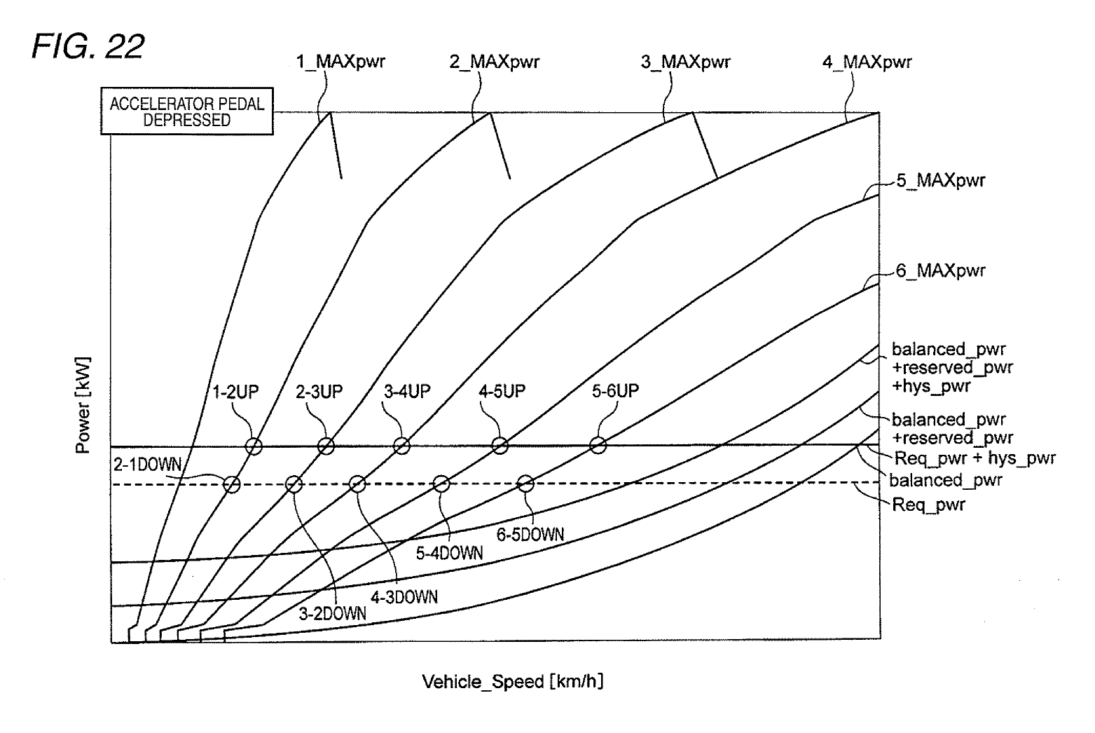

When the accelerator pedal is depressed, for example, in a case where the request power req_pwr is larger than the value obtained by adding the reserve power reserved_pwr to the balance power balanced_pwr (when the request power req_pwr is selected as the gear shifting decision power), shifts points are expressed as shown in FIG. 22. In FIG. 22, the maximum powers 1_MAXpwr to 6_MAXpwr are identical to the values shown in FIG. 21 since they represent the performance of a vehicle. The balance power balanced_pwr based on the running resistance roadR is an output required for the vehicle to sustain the vehicle speed, and is therefore set to the same value as that shown in FIG. 21. The value obtained by adding the reserve power reserved_pwr to the balance power balanced_pwr, and the value obtained by adding the reserve power reserved_pwr and hysteresis power hys_pwr to the balance power balanced_pwr are identical to the values shown in FIG. 21.

When the accelerator pedal is depressed, if the request power req_pwr calculated by the request output calculation means 32 is larger than the value obtained by adding the reserve power reserved_pwr to the balance power balanced_pwr (if the request power req_pwr is larger despite cruise control), the request power req_pwr is selected as the gear shifting decision power as expressed by the formula (1) for deciding downshift. Namely, an intersection between a curve indicating the request power req_pwr and a curve indicating any of the maximum powers 1_MAXpwr to 6_MAXpwr in the first to sixth speed stages for advancement is, as shown in FIG. 22, regarded as a downshift shift point.

For example, if it becomes impossible to output the request power req_pwr, which is requested by a driver, in terms of the maximum power 6_MAXpwr based on the maximum output of the engine 2 in the sixth speed stage for advancement, the sixth speed stage for advancement is shifted to the fifth speed stage for advancement (6-5DOWN). For example, if it becomes impossible to output the driver-requested request power req_pwr in terms of the maximum power 5_MAXpwr based on the maximum output of the engine 2 in the fifth speed stage for advancement, the fifth speed stage for advancement is shifted to the fourth speed stage for advancement (5-4DOWN). For example, if it becomes impossible to output the driver-requested request power req_pwr in terms of the maximum power 2_MAXpwr based on the maximum output of the engine 2 in the second speed stage for advancement, the second speed stage for advancement is shifted to the first speed stage for advancement (2-1DOWN).

As expressed by the formula (2) for deciding upshift, when the accelerator pedal is depressed, the value obtained by adding the hysteresis power hys_pwr to the request power req_pwr is selected as the gear shifting decision power. An intersection between a curve indicating the value, which is obtained by adding up the request power req_pwr and hysteresis power hys_pwr, and a curve indicating any of the maximum powers 1_MAXpwr to 6_MAXpwr in the first to sixth speed stages for advancement is, as shown in FIG. 22, regarded as an upshift shift point.

For example, when the first speed stage for advancement is designated, if it becomes possible to output the value, which is obtained by adding up the request power req_pwr and hysteresis power hys_pwr, in terms of the maximum power 2_MAXpwr based on the maximum output of the engine 2 in the second speed stage for advancement resulting from upshift, the first speed stage for advancement is shifted to the second speed stage for advancement (1-2UP). For example, when the second speed stage for advancement is designated, if it becomes possible to output the value, which is obtained by adding up the request power req_pwr and hysteresis power hys_pwr, in terms of the maximum power 3_MAXpwr based on the maximum output of the engine 2 in the third speed stage for advancement resulting from upshift, the second speed stage for advancement is shifted to the third speed stage for advancement (2-3UP). For example, when the fifth speed stage for advancement is designated, if it becomes possible to output the value, which is obtained by adding up the request power req_pwr and hysteresis power hys_pwr, in terms of the maximum power 6_MAXpwr based on the maximum output of the engine 2 in the sixth speed stage for advancement resulting from upshift, the fifth speed stage for advancement is shifted to the sixth speed stage for advancement (5-6UP).

(Calculation of a Reserve Output (Reserve Quantity))

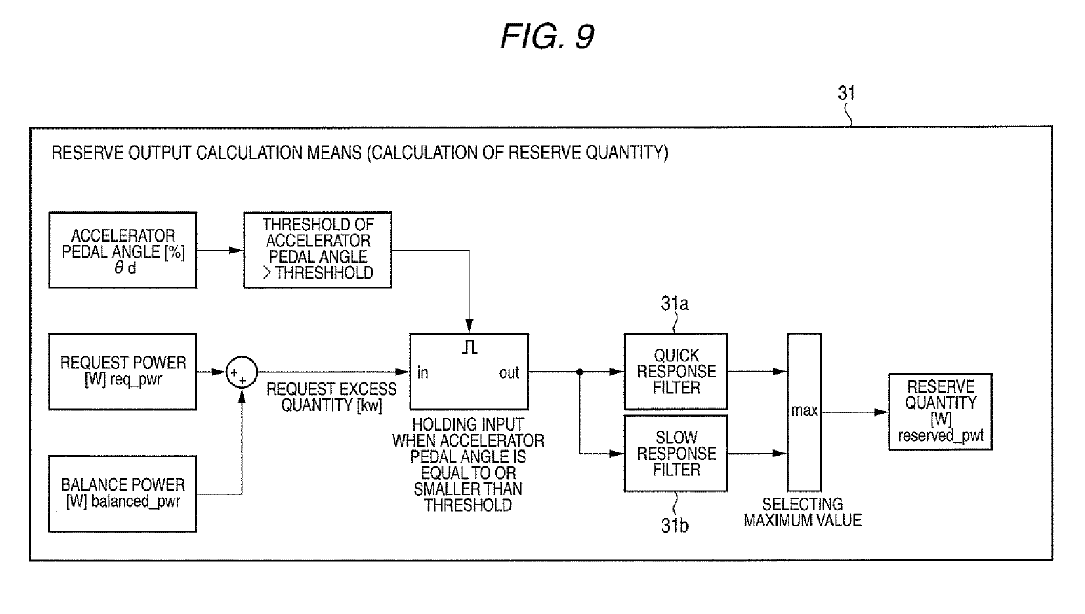

Next, calculation of a reserve output (a reserve quantity or reserve power reserved_pwr) will be described in conjunction with FIG. 9 to FIG. 16B. To begin with, an ideal value to which the reserve power reserved_pwr is set will be described below.

When the value obtained by adding up the balance power balanced_pwr and reserve power reserved_pwr is used to decide gear shifting according to the formula (1) or (2), that is, when the reserve power reserved_pwr is large, a tolerance for a change in a running situation is large. However, a speed stage resulting from downshift is likely to be selected in order to help sustain a vehicle speed against the running resistance roadR. In contrast, when the reserve power reserved_pwr is small, the tolerance for a change in a running situation is small. However, a speed stage resulting from upshift is likely to be selected in order to help sustain the vehicle speed against the running resistance roadR.

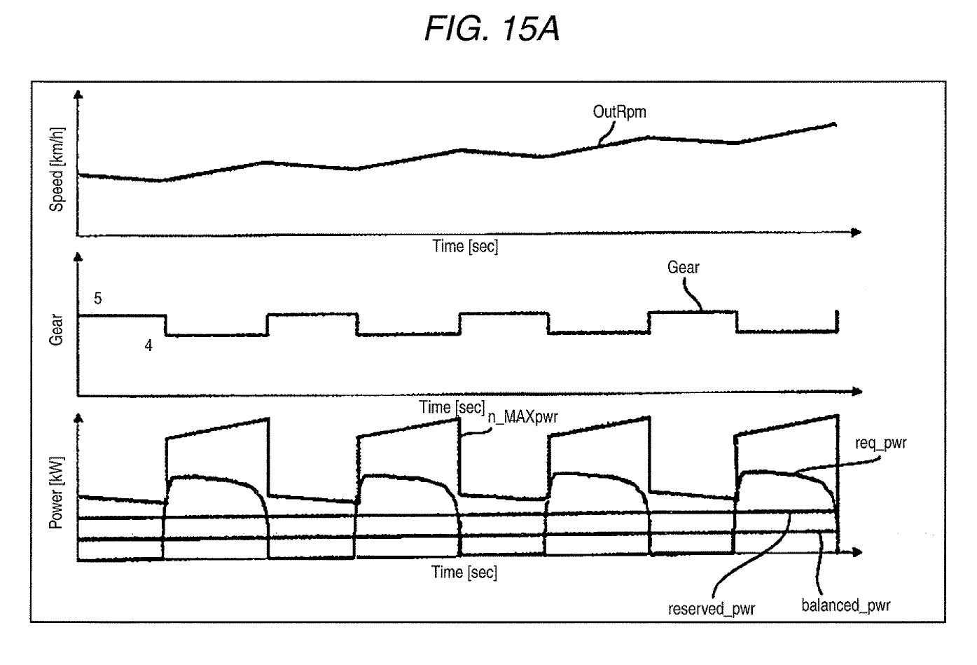

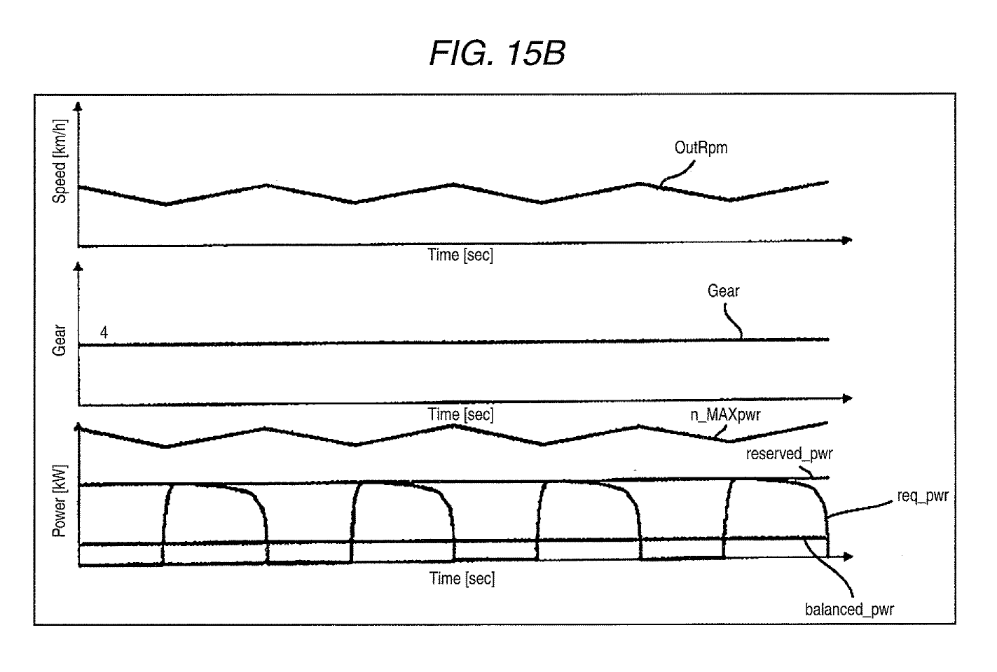

For example, as shown in FIG. 15A, when the reserve power reserved_pwr to be added to the balance power balanced_pwr is small, the fifth speed stage for advancement resulting from upshift is likely to be selected. However, the maximum power 5_MAXpwr in the fifth speed step is small. Therefore, if a driving tendency is such that the request power req_pwr requested by a driver is frequently increased or decreased, every time the request power req_pwr exceeds the reserve power reserved_pwr, downshift is decided, that is, busy shift takes place. When a vehicle is downshifted to be set to the fourth speed stage for advancement, the maximum power n_MAXpwr is set to the maximum power 4_MAXpwr larger than the maximum power 5_MAXpwr. Therefore, in part FIG. 15A, the maximum power n_MAXpwr is plotted like a sawtooth along with the progress of busy shift.

In this case, for example, as shown in FIG. 15B, if the reserve power reserved_pwr to be added to the balance power balanced_pwr is large, a tolerance that helps decide gear shifting is large. Even when a driving tendency is such that the request power req_pwr requested by a driver is frequently increased or decreased, the request power req_pwr will not exceed the value obtained by adding up the balance power balanced_pwr and reserve power reserved_pwr. Downshift is not decided, but a vehicle is run while being retained in the fourth speed stage for advancement. Namely, busy shift is prevented.

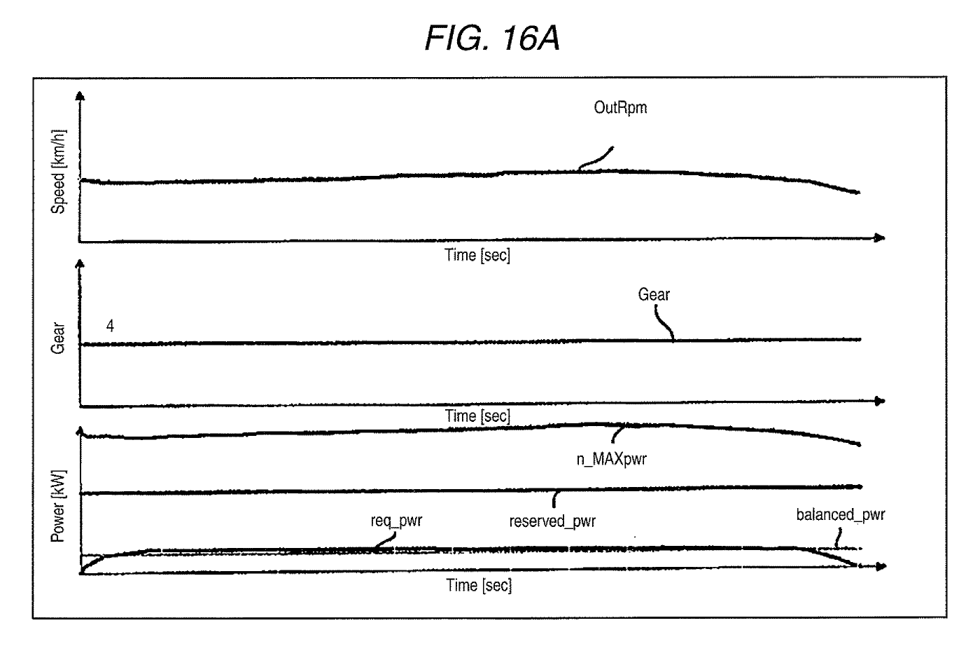

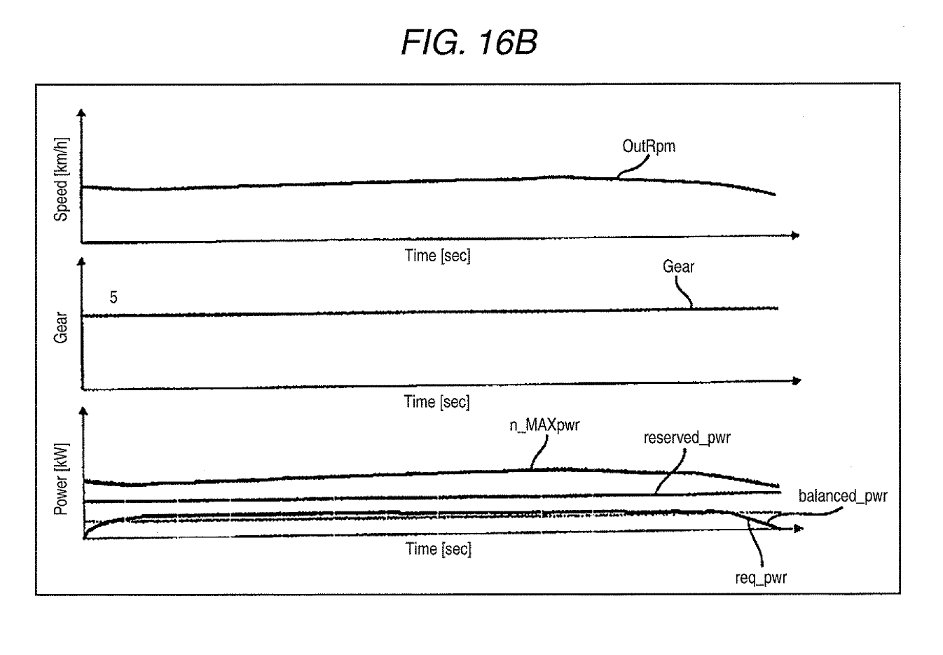

However, as shown in FIG. 16A, for example, if the reserve power reserved_pwr to be added to the balance power balanced_pwr remains large, the value obtained by adding up the balance power balanced_pwr and reserve power reserved_pwr gets larger than the maximum power 5_MAXpwr. According to the formula (1) or (2), the fourth speed stage for advancement is selected. When such a driving tendency is such that the request power req_pwr requested by a driver is substantially retained at a small value which balances with the balance power balanced_pwr, although a vehicle can be, as shown in FIG. 16B, run in the fifth speed stage for advancement without busy shift, the fourth speed stage for advancement is selected as shown in FIG. 16A. In other words, a low speed stage is selected because a tolerance is too large. This hinders improvement in fuel consumption.

Accordingly, in order to accomplish both prevention of busy shift and improvement in fuel consumption, when a driving tendency is such that the request power req_pwr requested by a driver frequently increases or decreases, the reserve power reserved_pwr is increased. When the driving tendency is such that the request power req_pwr requested by the driver remains substantially constant at a small value, the reserve power reserved_pwr is ideally decreased.

Conceivably, the value of the reserve power reserved_pwr is varied depending on, for example, the request power req_pwr requested by a driver. However, needless to say, since the variation in the request power req_pwr requested by the driver is unpredictable, when the request power req_pwr is reflected on calculation of the reserve power reserved_pwr, a request whose frequency is large is reflected but an unexpected (irregular) request should not preferably be reflected.

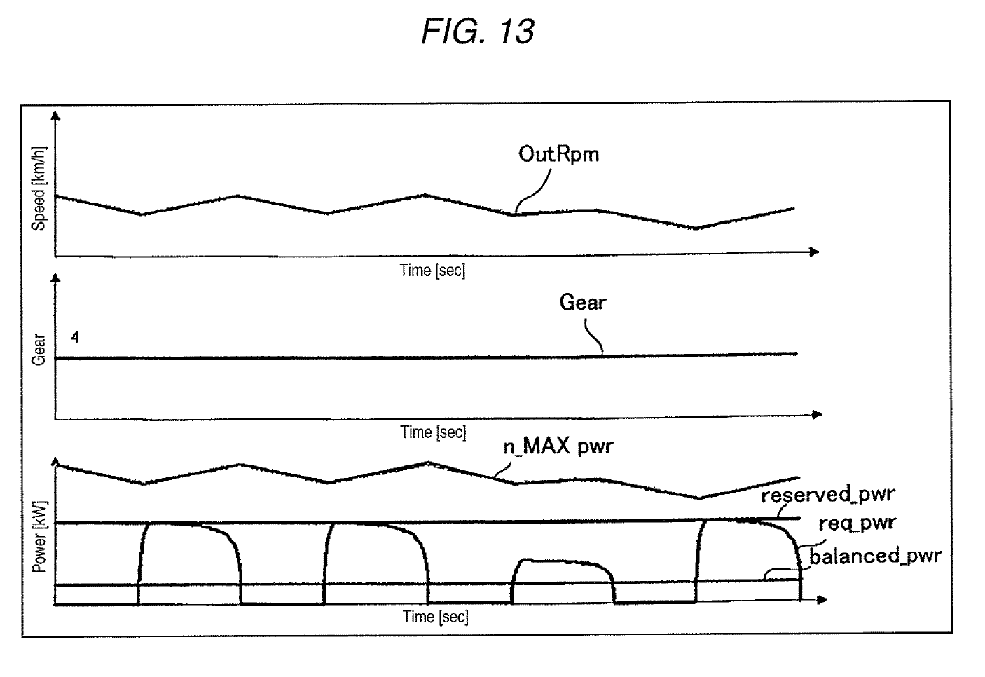

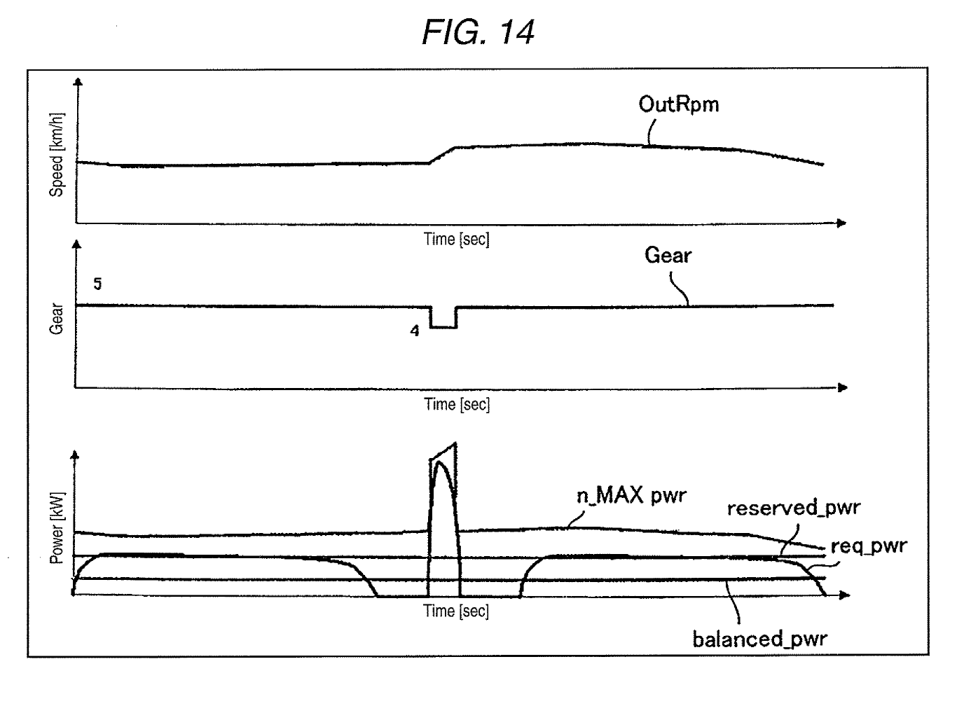

Specifically, when the request power req_pwr is requested by a driver as shown in FIG. 13, as long as the value of the request power req_pwr, which is plotted as the third leftmost boss in the drawing and is smaller than the other values, is not reflected on the reserve power reserved_pwr, the value of the request power plotted as the fourth leftmost boss in the drawing will not exceed the reserve power reserved_pwr. This means that busy shift is prevented. When the request power req_pwr is generated by the driver as shown in FIG. 14, as long as the value of the request power req_pwr that is plotted as a central boss in the drawing and is unexpectedly larger than the other values is not reflected on the reserve power reserved_pwr, the request power req_pwr and reserve power reserved_pwr are substantially squared with each other thereafter. This contributes to improvement in fuel consumption.

In order to designate the foregoing ideal reserve power reserved_pwr, in the present embodiment, the reserve output calculation means 31 calculates the reserve power reserved_pwr as shown in FIG. 9. Specifically, first, the reserve output calculation means 31 calculates a quantity, by which the request power req_pwr exceeds the balance power balanced_pwr, as a request excess quantity over_pwr (subtracts the balance power balanced_pwr from the request power req_pwr so as to calculate the request excess quantity over_pwr). In addition, if the accelerator pedal angle θd detected by the accelerator pedal angle sensor 71 is smaller than a predetermined threshold THRESHOLD for the accelerator pedal angle, the request excess quantity over_pwr is set to a small value (minus value). When the small value is used to calculate the reserve power reserved_pwr, there is a fear that the reserve power reserved_pwr may decrease rapidly. Therefore, the request excess quantity over_pwr obtained when the accelerator pedal angle θd falls below the predetermined threshold THRESHOLD for the accelerator pedal angle is sustained (held) as an input value.

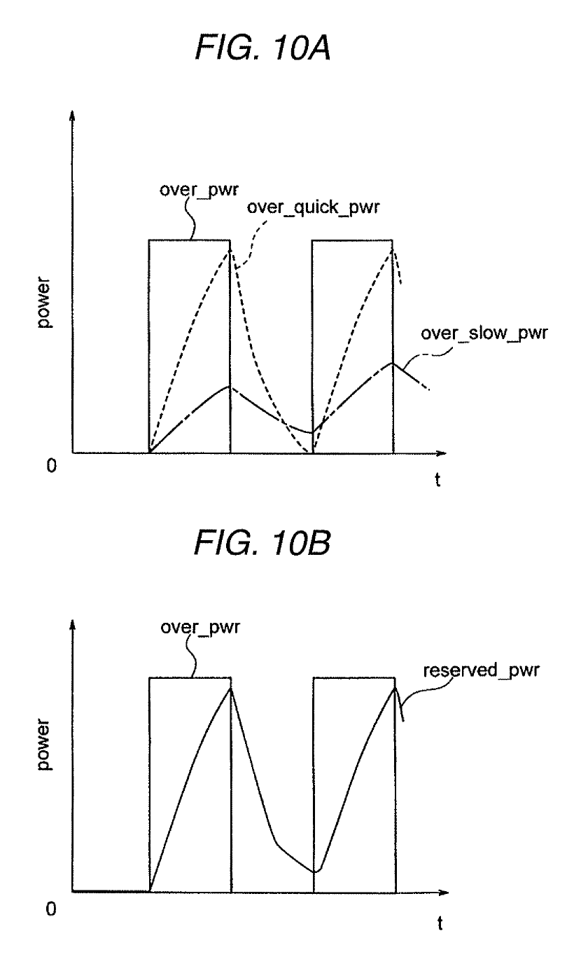

Thereafter, the reserve output calculation means 31 applies a quick response filter 31a, which responds quickly, and a slow response filter 31b, which responds slowly, to the thus calculated request excess quantity over_pwr. The quick response filter 31a is a filter that quickly calculates a value responsively to a change in the request excess quantity over_pwr. The slow response filter 31b is a filter that more slowly calculates a value responsively to the change in the request excess quantity over_pwr than the quick response filter 31a does. When the request excess quantity over_pwr changes as shown in FIG. 10A, a value calculated by the quick response filter 31a is a quick response value over_quick_pwr, and a value calculated by the slow response filter 31b is a slow response value over_slow_pwr. The reserve output calculation means 31 adopts, as shown in FIG. 10B, a larger one of the quick response value over_quick_pwr and slow response value over_slow_pwr as the reserve power reserved_pwr.

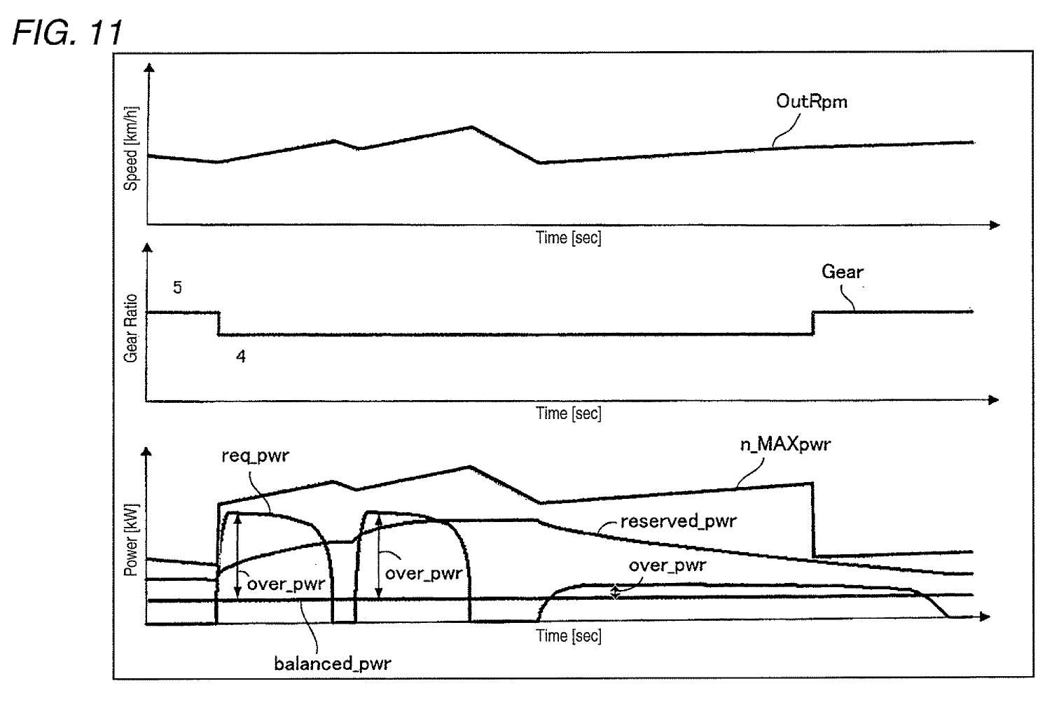

Calculation of the reserve power reserved_pwr by the reserve output calculation means 31 will be described in line with an example of running shown in FIG. 11. For example, while a vehicle is run in the fifth speed stage for advancement, if a driver steps on the accelerator pedal so as to accelerate the vehicle, the request power req_pwr calculated by the reserve output calculation means 31 increases. Accordingly, the request excess quantity over_pwr calculated by the reserve output calculation means 31 increases. The reserve power reserved_pwr is calculated based on the maximum values of the quick response value over_quick_pwr and slow response value over, slow_pwr, and increased. At this time, the request power req_pwr gets larger than the current gear ratio (in the fifth speed stage for advancement) maximum power 5_MAXpwr. The downshift decision means 51 decides downshift according to the formula (1), and shifts the fifth speed stage for advancement to the fourth speed stage for advancement. Along with the downshift, the current gear ratio maximum power n_MAXpwr is changed to the maximum power 4_MAXpwr in the fourth speed stage for advancement. Since the request power req_pwr is smaller than the maximum power 4_MAXpwr, downshift causing a decrease to the third speed stage for advancement is not decided.

Thereafter, if the driver steps on the accelerator pedal so as to accelerate the vehicle, both the request power req_pwr and the request excess quantity over_pwr increase. Accordingly, the maximum values of the quick response value over_quick_pwr and slow response value over_slow_pwr increase before decreasing due to a response delay. In other words, the reserve power reserved_pwr further increases. When the reserve power reserved_pwr is thus increased, compared with when the reserve power reserved_pwr is small, a speed stage resulting from downshift is likely to be selected. Therefore, a tolerance that helps decide gear shifting is increased. Eventually, busy shift is prevented.

Thereafter, if the driver steps on the accelerator pedal to such an extent that the vehicle speed is sustained, the request power req_pwr calculated by the reserve output calculation means 31 is calculated to be a value slightly larger than the balance power balanced_pwr. Accordingly, the request excess quantity over_pwr calculated by the reserve output calculation means 31 gets smaller. The reserve power reserved_pwr based on the maximum values of the quick response value over_quick_pwr and slow response value over_slow_pwr decreases. If the value obtained by adding up the balance power balanced_pwr, reserve power reserved_pwr, and hysteresis power hys_pwr gets smaller than the post-upshift maximum power 5_MAXpwr (in the fifth speed stage for advancement), the upshift decision means 52 decides upshift according to the formula (2), and shifts the fourth speed stage for advancement to the fifth speed stage for advancement. When the reserve power reserved_pwr is decreased, a tolerance that helps decide gear shifting is reduced. However, compared with a case where the reserve power reserved_pwr is large, a speed stage resulting from upshift is likely to be selected. Eventually, improvement in fuel consumption is achieved.

(Comparing Examples of Running)

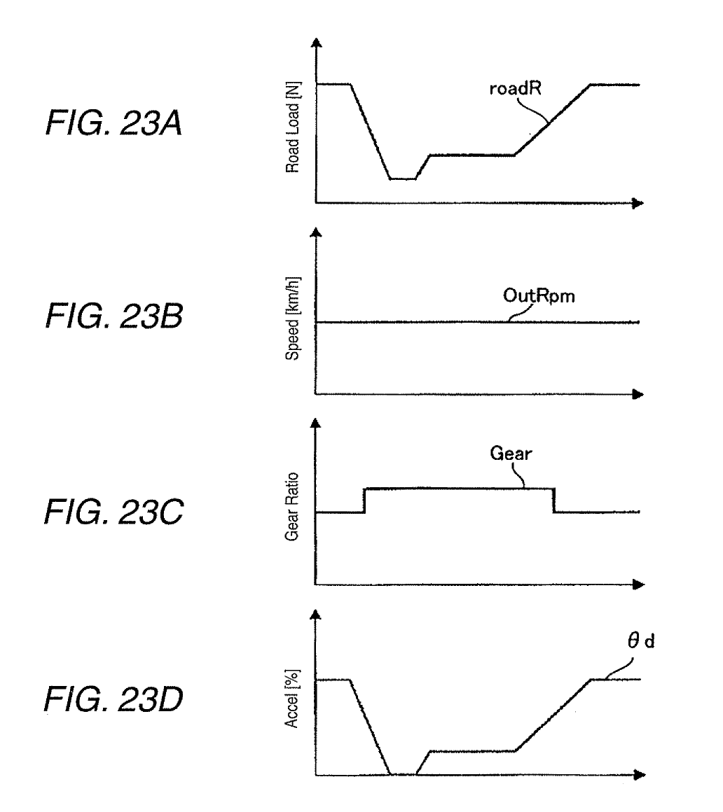

Differences among the aforesaid gear shifting decision through computation performed by the control system 1 for an automatic transmission, the conventional gear shifting decision based on shift maps, and the gear shifting decision based on shift maps produced by modifying the conventional shift maps for the purpose of improving fuel consumption will be described below in conjunction with FIG. 23A to FIG. 25D. The examples of running shown in FIG. 23A to FIG. 25D will be described on the assumption that, for convenience's sake, a driver acts on the accelerator pedal in the same manner under a condition that the same running resistance roadR is generated.

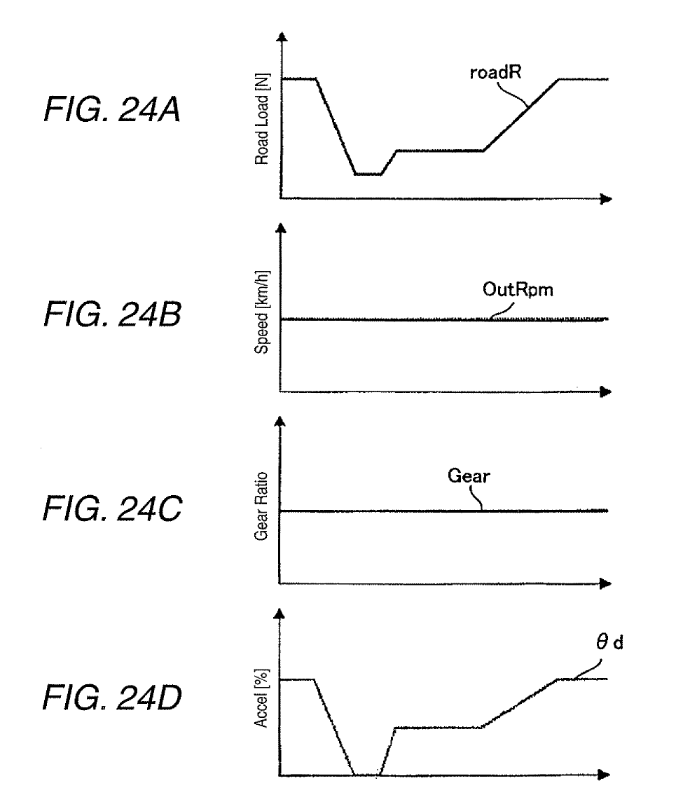

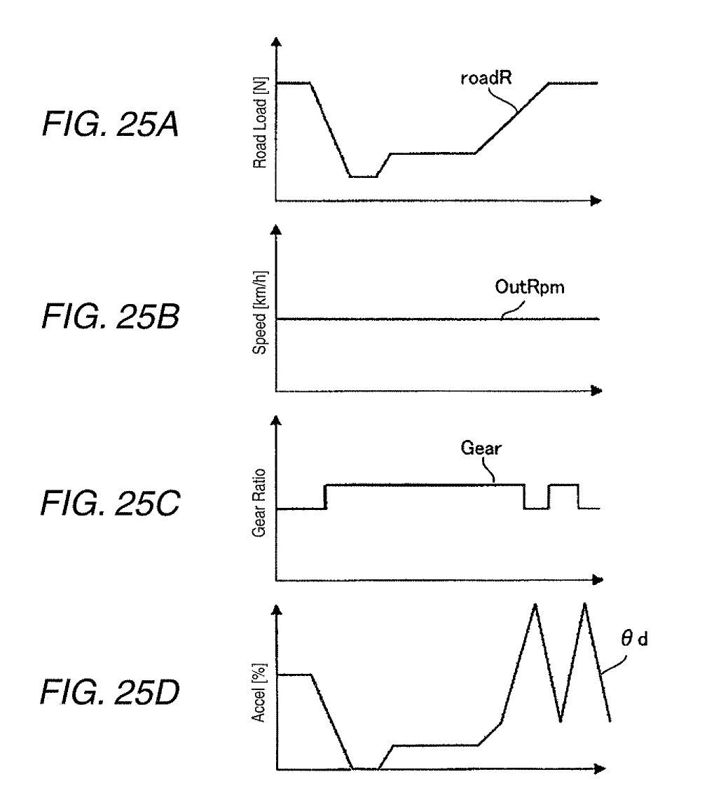

Assume that, for example, as shown in FIG. 23A, FIG. 24A, and FIG. 25A, the running resistance roadR changes from a large value to a small value due to the inclination of a road, and then gradually increases. A driver shall, as shown in FIG. 23D, FIG. 24D, and FIG. 25D, changes the accelerator pedal angle θd in line with the inclination of a road or the like so as to retain, as shown in FIG. 23B, FIG. 248, and FIG. 258, the vehicle speed (the number of revolutions of the output shaft OutRpm) at a constant value.

As shown in FIG. 24C, when gear shifting is decided based on the conventional shift maps, since the shift maps are designed so that shift points will be determined with a tolerance, which helps decide gear shifting, increased, or in other words, since the reserve power reserved_pwr is sufficiently large, gear shifting will not occur. However, a vehicle is run in a speed stage resulting from downshift. Improvement in fuel consumption is not expected.

As shown in FIG. 25C, when gear shifting is decided based on the shift maps produced by modifying the conventional shift maps for the purpose of improving fuel consumption, since shift points are determined with a tolerance, which helps decide gear shifting, decreased, or in other words, since the reserve power reserved_pwr is small, a speed stage resulting from upshift is selected. Therefore, a low-revolution speed domain of low engine speeds is frequently used, and improvement in fuel consumption is expected. However, as illustrated, since a vehicle is not accelerated in the same manner as a driver wants to accelerate the vehicle, an event that the driver excessively steps on the accelerator pedal is invited. This brings about busy shift. The accelerator pedal angle varies to go up and down, and drivability is impaired.

In the gear shifting decision through computation performed by the control system 1, as shown in FIG. 23C, when the running resistance roadR decreases, the balance power balanced_pwr decreases. Therefore, a speed stage resulting from upshift is selected and improvement in fuel consumption is achieved. Thereafter, when the running resistance roadR increases, the balance power balanced_pwr also increases. A speed stage resulting from downshift is therefore selected. In the present gear shifting control, busy shift shown in FIG. 25C does not occur but drivability is ensured and improvement in fuel consumption is achieved.

(Summary of the Present Invention)

As described so far, according to the control system 1 for an automatic transmission, as long as a domain of values of the accelerator pedal angle θd within which, for example, a driver is not permitted to accelerate a vehicle but is merely permitted to sustain a vehicle speed is designated, a speed stage is selected based on the balance power balanced_pwr and reserve power reserved_pwr associated with the running resistance roadR the vehicle incurs. For example, when a domain of values of the accelerator pedal angle θd within which the driver is permitted to accelerate the vehicle is designated, a speed stage is selected based on the request power req_pwr. Therefore, improvement in fuel consumption in a running state in which the vehicle speed is sustained can be achieved, and the speed stage that meets the driver's acceleration request can be selected. Drivability can be ensured. Therefore, feasible computation for selecting a speed stage can be achieved without the necessity of the shift maps, that is, a novel computation method for selecting a speed stage can be provided. Since a speed stage is selected through computation, if numerical values to be used for computation are optimized, corrected based on a running situation, or learned, or in other words, if speed stage selection control is upgraded, further improvement in fuel consumption can be achieved.

A larger one of an output, which is obtained by adding the reserve power reserved_pwr to the balance power balanced_pwr, and the request power req_pwr can be adopted as a value (first value) for use in deciding downshift. An output obtained by adding the hysteresis power hys_pwr, which is used to prevent hunting, to the larger one of the output, which is obtained by adding the reserve power reserved_pwr to the balance power balanced_pwr, and the request power req_pwr may be adopted as a value (third value) for use in deciding upshift. In a running state in which a vehicle speed is sustained, while busy shift is prevented based on the reserve power reserved_pwr, fuel consumption can be improved. In a running state in which a driver requests acceleration, a speed stage can be selected based on the request power req_pwr.

Further, the current speed stage maximum power n_MAXpwr may be adopted as a value (second value) serving as a reference for deciding downshift, and the post-upshift maximum power n+_MAXpwr may be adopted as a value (fourth value) serving as a reference for deciding upshift. If a vehicle speed is not sustained because the sustention will exceed the output ability of a vehicle in the current speed stage, or if acceleration is requested although the acceleration will exceed the output ability of a vehicle at the current speed stage, downshift is decided. In contrast, if the output ability of the vehicle in a speed stage resulting from upshift is large enough to sustain the vehicle speed or to meet an acceleration request, upshift is decided. Compared with a case where an output obtained by subtracting a reserve capacity with which an engine speed can be raised is used as a reference, since the reserve capacity is not left, a speed stage resulting from upshift is like to be selected. Further improvement in fuel consumption can be achieved.

The control system 1 for an automatic transmission includes the running resistance calculation means 23 capable of calculating the running resistance roadR occasionally.

Therefore, the precision in selecting a speed stage through computation can be improved. Accordingly, further improvement in fuel consumption can be achieved.

When a vehicle is normally run, the request output calculation means 32 calculates the requested request power req_pwr on the basis of a driving operation. Therefore, a gear ratio can be selected in response to a driver's acceleration request. When cruise control is executed, the request power req_pwr requested by the vehicle speed sustention control means 60 is calculated as an output needed to accelerate the vehicle until the vehicle speed reaches a target vehicle speed. Therefore, when control is executed in order to sustain the vehicle speed of the vehicle, not only the vehicle speed is sustained but also a gear ratio needed to quickly accelerate the vehicle until the vehicle speed reaches the target vehicle speed can be selected.

When the post-downshift maximum power n·_MAXpwr is smaller than the current gear ratio maximum power n_MAXpwr, that is, when the output of a vehicle is not increased despite downshift, the downshift decision means 51 inhibits downshift decision. Therefore, unnecessary downshift can be prevented.

### Second Embodiment

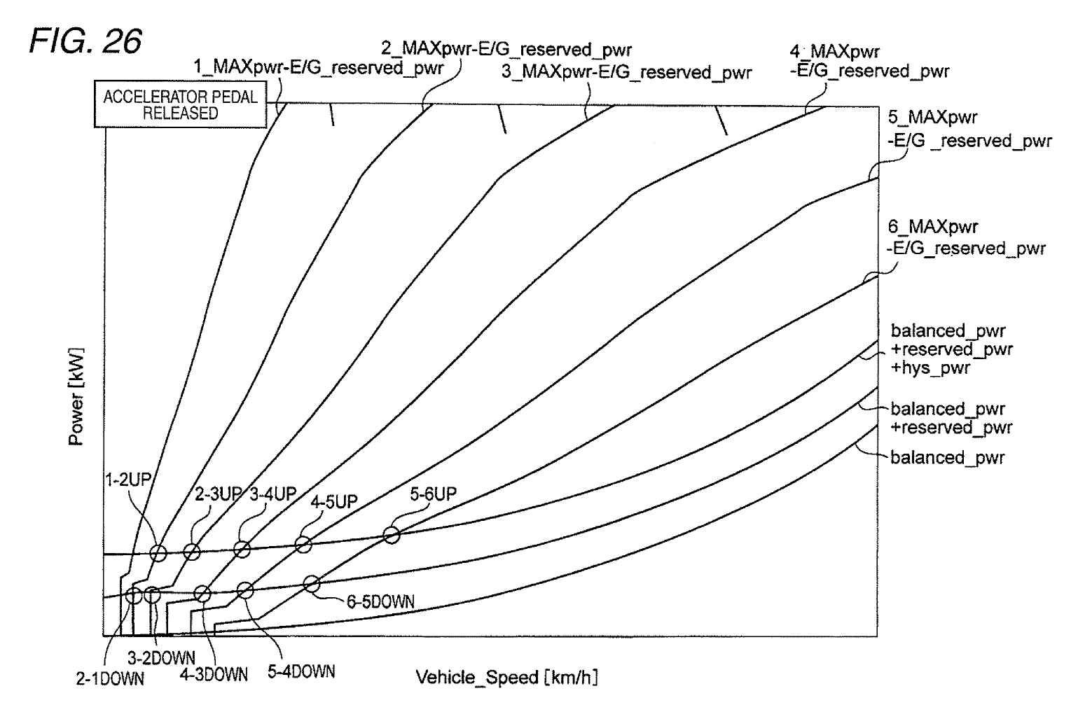

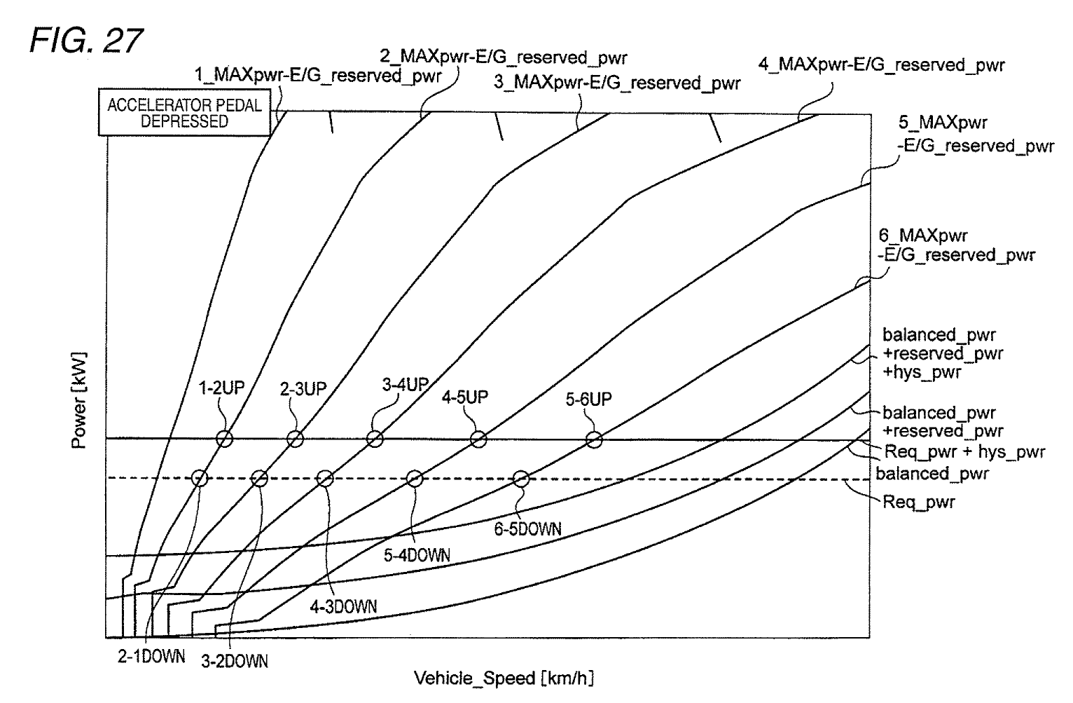

The second embodiment that is a modification of the first embodiment will be described in conjunction with FIG. 26 and FIG. 27. In the second embodiment, compared with the first embodiment, values to be used by the downshift decision means 51 and upshift decision means 52 in order to decide downshift or upshift are modified.

In the first embodiment, for deciding downshift, the current gear ratio maximum power n_MAXpwr is used as a reference. For deciding upshift, the post-upshift maximum power n+_MAXpwr is used as a reference. In the second embodiment, a value obtained by subtracting a reserve capacity E/G_reserved_pwr, with which the number of revolutions of the engine 2 can be increased, from the current gear ratio maximum power or post-upshift maximum power is adopted.

In the second embodiment, for deciding downshift, a value obtained by subtracting the reserve capacity E/G_reserved_pwr from the current gear ratio maximum power n_MAXpwr is adopted as the second value, and a larger one of a value, which is obtained by adding the reserve power reserved_pwr to the balance power balanced_pwr, and the request power req_pwr is adopted as the first value. Calculation for deciding downshift is expressed by a formula (3) below.

n_MAXpwr−E/G_reserved_pwr<MAX[(balanced_pwr+reserved_pwr),req_pwr] (3)

For deciding upshift, a value obtained by subtracting the reserve capacity E/G_reserved_pwr from the post-upshift maximum power n+_MAXpwr is adopted as the fourth value, and a value obtained by adding the hysteresis power hys_pwr to a larger one of a value, which is obtained by adding the reserve power reserved_pwr to the balance power balanced_pwr, and the request power req_pwr is adopted as the third value. Calculation for deciding upshift is expressed by a formula (4) below.

n+_MAXpwr−E/G_reserved_pwr>MAX[(balanced_pwr+reserved_pwr),req_pwr]+hys_pwr (4)

(Shift Points with the Accelerator Pedal Released)

In the second embodiment, as shown in FIG. 26, when a vehicle is normally run (run with cruise control not executed) and the accelerator pedal is released, the request power req_pwr calculated by the request output calculation means 32 is substantially 0. According to the formula (3) for deciding downshift, a value obtained by adding the reserve power reserved_pwr to the balance power balanced_pwr is selected as a gear shifting decision power. As shown in FIG. 26, an intersection between a curve, which indicates the value obtained by adding the reserve power reserved_pwr to the balance power balanced_pwr, and a curve indicating any of values obtained by subtracting the reserve capacity E/G_reserved_pwr from the maximum powers 1_MAXpwr to 6_MAXpwr in the first to sixth speed stages for advancement is regarded as a downshift shift point.

For example, If it becomes impossible to output the value, which is obtained by adding the reserve power reserved_pwr to the balance power balanced_pwr, in terms of the second value 6_MAXpwr-E/G_reserved_pwr obtained by subtracting the reserve capacity from the maximum output of the engine 2 in the sixth speed stage for advancement, the sixth speed stage for advancement is shifted to the fifth speed stage for advancement (6-5DOWN). For example, if it becomes impossible to output the value, which is obtained by adding the reserve power reserved_pwr to the balance power balanced_pwr, in terms of the second value 5_MAXpwr-E/G_reserved_pwr obtained by subtracting the reserve capacity from the maximum output of the engine 2 in the fifth speed stage for advancement, the fifth speed stage for advancement is shifted to the fourth speed stage for advancement (5-4DOWN). For example, if it becomes impossible to output the value, which is obtained by adding the reserve power reserved_pwr to the balance power balanced_pwr, in terms of the second value 2_MAXpwr-E/G_reserved_pwr obtained by subtracting the reserve capacity from the maximum output of the engine 2 in the second speed stage for advancement, the second speed stage for advancement is shifted to the first speed stage for advancement (2-1DOWN)

As expressed by the formula (4) for deciding upshift, when the accelerator pedal is released, a value obtained by adding the reserve power reserved_pwr and hysteresis power hys_pwr to the balance power balanced_pwr is selected as a gear shifting decision power. As shown in FIG. 26, an intersection between a curve, which indicates the value obtained by adding the reserve power reserved_pwr and hysteresis power hys_pwr to the balance power balanced_pwr, and any of curves indicating the maximum powers 1_MAXpwr to 6_MAXpwr in the first to sixth speed stages for advancement is regarded as an upshift shift point.

Specifically, for example, when the first speed stage for advancement is designated, if it becomes possible to output the value, which is obtained by adding the reserve power reserved_pwr and hysteresis power hys_pwr to the balance power balanced_pwr, in terms of the fourth value 2_MAXpwr-E/G_reserved_pwr obtained by subtracting the reserve capacity from the maximum output of the engine 2 in the second speed stage for advancement resulting from upshift, the first speed stage for advancement is shifted to the second speed stage for advancement (1-2UP). For example, when the second speed stage for advancement is designated, if it becomes possible to output the value, which is obtained by adding the reserve power reserved_pwr and hysteresis power hys_pwr to the balance power balanced_pwr, in terms of the fourth value 3_MAXpwr-E/G_reserved_pwr obtained by subtracting the reserve capacity from the maximum output of the engine 2 in the third speed stage for advancement resulting from upshift, the second speed stage for advancement is shifted to the third speed stage for advancement (2-3UP). For example, when the fifth speed stage for advancement is designated, if it becomes possible to output the value, which is obtained by adding the reserve power reserved_pwr and hysteresis power hys_pwr to the balance power balanced_pwr, in terms of the fourth value 6_MAXpwr-E/G_reserved_pwr obtained by subtracting the reserve capacity from the maximum output of the engine 2 in the sixth speed stage for advancement resulting from upshift, the fifth speed stage for advancement is shifted to the sixth speed stage for advancement (5-6UP).

(Shift Points with the Accelerator Pedal Depressed)

In contrast, when the accelerator pedal is depressed, if the request power calculated by the request output calculation means 32 is larger than a value obtained by adding the reserve power reserved_pwr to the balance power balanced_pwr (even when cruise control is executed, if the request power req_pwr is larger), the request power req_pwr is selected as a gear shifting decision power as expressed by the formula (3) for deciding downshift. As shown in FIG. 27, an intersection between a curve, which indicates the request power req_pwr, and a curve indicating any of values obtained by subtracting the reserve capacity E/G_reserved_pwr from the maximum powers 1_MAXpwr to 6_MAXpwr in the first to sixth speed stages for advancement is regarded as a downshift shift point.

Specifically, for example, if it becomes impossible to output the request power req_pwr, which is requested by a driver, in terms of the second value 6_MAXpwr-E/G_reserved_pwr obtained by subtracting the reserve capacity from the maximum output of the engine 2 in the sixth speed stage for advancement, the sixth speed stage for advancement is shifted to the fifth speed stage for advancement (6-5DOWN). For example, if it becomes impossible to output the request power req_pwr, which is requested by a driver, in terms of the second value 5_MAXpwr-E/G_reserved_pwr obtained by subtracting the reserve capacity from the maximum output of the engine 2 in the fifth speed stage for advancement, the fifth speed stage for advancement is shifted to the fourth speed stage for advancement (5-4DOWN). For example, if it becomes impossible to output the request power req_pwr, which is requested by a driver, in terms of the second value 2_MAXpwr-E/G_reserved_pwr obtained by subtracting the reserve capacity from the maximum output of the engine 2 in the second speed stage for advancement, the second speed stage for advancement is shifted to the first speed stage for advancement (2-1DOWN).

As expressed by the formula (4) for deciding upshift, when the accelerator pedal is depressed, a value obtained by adding the hysteresis power hys_pwr to the request power req_pwr is selected as a gear shifting decision power. As shown in FIG. 27, an intersection between a curve, which indicates the value obtained by adding the hysteresis power hys_pwr to the request power req_pwr, and a curve indicating any of values obtained by subtracting the reserve capacity E/G_reserved_pwr from the maximum powers 1_MAXpwr to 6_MAXpwr in the first to sixth speed stages for advancement is regarded as an upshift shift point.

Specifically, for example, when the first speed stage for advancement is designated, if it becomes possible to output the value, which is obtained by adding up the request power req_pwr and hysteresis power hys_pwr, in terms of the fourth value 2_MAXpwr-E/G_reserved_pwr obtained by subtracting the reserve capacity from the maximum output of the engine 2 in the second speed stage for advancement resulting from upshift, the first speed stage for advancement is shifted to the second speed stage for advancement (1-2UP). For example, when the second speed stage for advancement is designated, if it becomes possible to output the value, which is obtained by adding up the request power req_pwr and hysteresis power hys_pwr, in terms of the fourth value 3_MAXpwr-E/G_reserved_pwr obtained by subtracting the reserve capacity from the maximum output of the engine 2 in the third speed stage for advancement resulting from upshift, the second speed stage for advancement is shifted to the third speed stage for advancement (2-3UP). For example, when the fifth speed stage for advancement is designated, if it becomes possible to output the value, which is obtained by adding up the request power req_pwr and hysteresis power hys_pwr, in terms of the fourth value 6_MAXpwr-E/G_reserved_pwr obtained by subtracting the reserve capacity from the maximum output of the engine 2 in the sixth speed stage for advancement resulting from upshift, the fifth speed stage for advancement is shifted to the sixth speed stage for advancement (5-6UP).

(Summary of the Second Embodiment)

According to the second embodiment, an output obtained by subtracting the reserve capacity E/G_reserved_pwr, with which the number of revolutions of the engine 2 can be increased, from the current gear ratio maximum power n_MAXpwr may be adopted as a value (second value) serving as a reference for deciding downshift. An output obtained by subtracting the reserve capacity E/G_reserved_pwr from the post-upshift maximum output n+_MAXpwr may be adopted as a value (fourth value) serving as a reference for deciding upshift. Namely, since the output obtained by subtracting the reserve capacity E/G reserved_pwr with which the number of revolutions of the engine 2 can be increased is used as the reference, the second embodiment is preferably adapted to a vehicle in which the engine 2 itself increases the number of revolutions thereof at the time of shifting gears. The present embodiment has been described by taking an example in which an automatic transmission carries out multistage gear shifting. The present invention may be adapted to, for example, a vehicle in which the gear ratio in a continuously variable transmission is set to a quasi-value. In such a continuously variable transmission, clutches or the like will not be released during gear shifting, and power transmission between an engine and driving wheels will not be discontinued. Therefore, the reserve capacity E/G_reserved_pwr of the engine itself is needed in order to increase the number of revolutions of a revolutionary system in a power transmission route by shifting gears.

In points other than the point described in relation to the second embodiment, the constitution, operation, and advantage of the second embodiment are identical to those of the first embodiment. An iterative description will be omitted.

### Third Embodiment

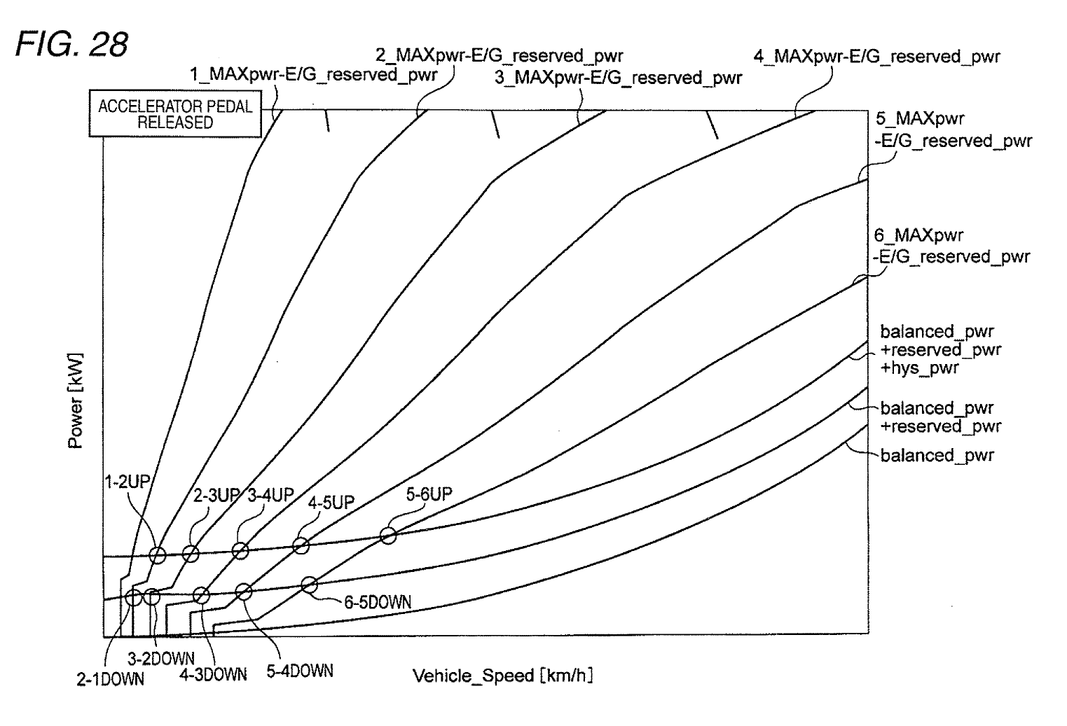

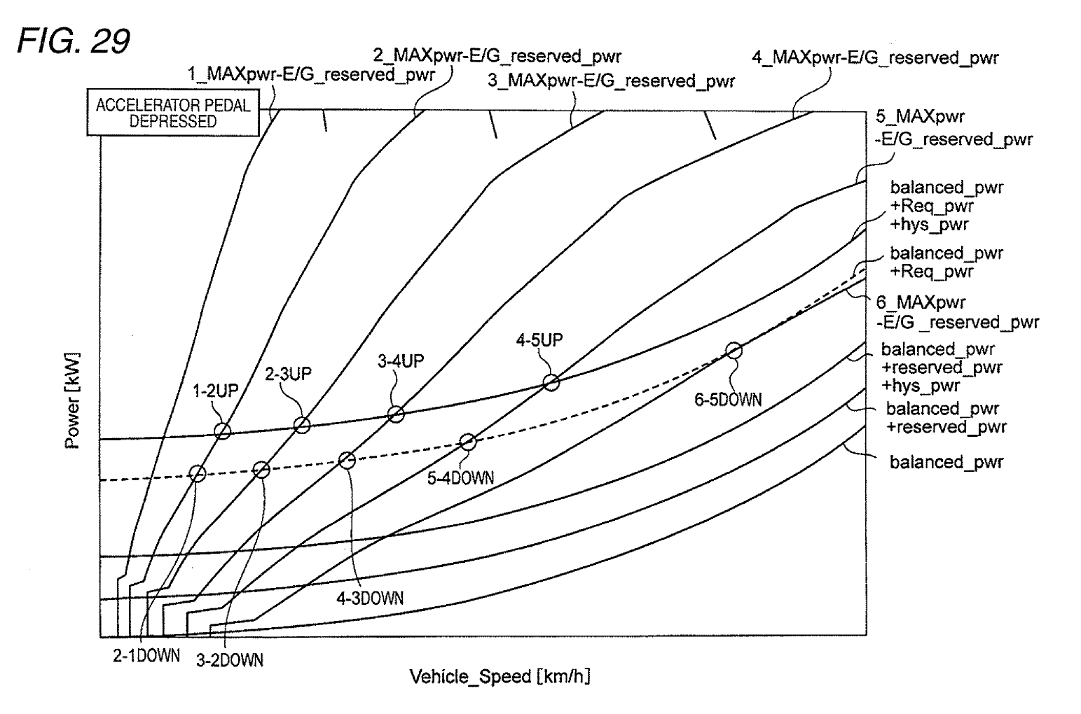

The third embodiment that is a modification of the second embodiment will be described in conjunction with FIG. 28 and FIG. 29. In the third embodiment, compared with the second embodiment, values to be used by the downshift decision means 51 and upshift decision means 52 in order to decide downshift or upshift are modified.

In the second embodiment, for deciding downshift, the larger one of the value, which is obtained by adding the reserve power reserved_pwr to the balance power balanced_pwr, and the request power req_pwr is adopted as the first value. For deciding upshift, the value obtained by adding the hysteresis power hys_pwr to the larger one of the value, which is obtained by adding the reserve power reserved_pwr to the balance power balanced_pwr, and the request power req_pwr is adopted as the third value. In the third embodiment, a value obtained by adding the larger one of the reserve power reserved_pwr and request power req_pwr to the balance power balanced_pwr is adopted as the first and third values.

For deciding downshift in the third embodiment, a value obtained by subtracting the reserve capacity E/G_reserved_pwr from the current gear ratio maximum power n_MAXpwr is adopted as the second value, and a value obtained by adding the larger one of the reserve power reserved_pwr and request power req_pwr to the balance power balanced_pwr is adopted as the first value. Calculation for deciding downshift is expressed by a formula (5) below.

n_MAXpwr-E/G_reserved_pwr<balanced_pwr+MAX[(reserved_pwr,req_pwr] (5)

For deciding upshift, a value obtained by subtracting the reserve capacity E/G_reserved_pwr from the post-upshift maximum power n+_MAXpwr is adopted as the third value, and a value obtained by adding the hysteresis power hys_pwr to the value obtained by adding the larger one of the reserved power reserved_pwr and request power req_pwr to the balance power balanced_pwr is adopted as the fourth value. Calculation for deciding upshift is expressed by a formula (6) below.

n+_MAXpwr-E/G_reserved_pwr>balanced_pwr+MAX[reserved_pwr,req_pwr]+hys_pwr (6)

(Shift Points with the Accelerator Pedal Released)

In the second embodiment, as shown in FIG. 28, when a vehicle is normally run (run with cruise control not executed) and the accelerator pedal is released, the request power req_pwr calculated by the request output calculation means 32 is substantially 0. As expressed by the formula (5) for deciding downshift, the value obtained by adding the reserve value reserved_pwr to the balance power balanced_pwr is selected as a gear shifting decision power. As shown in FIG. 28, an intersection between a curve, which indicates the value obtained by adding the reserve value reserved_pwr to the balance power balanced_pwr, and a curve indicating the value obtained by subtracting the reserve capacity E/G_reserved_pwr from any of the maximum powers 1_MAXpwr to 6_MAXpwr in the first to sixth speed stages for advancement is regarded as a downshift shift point.

Specifically, for example, if it becomes impossible to output the value, which is obtained by adding the reserve power reserved_pwr to the balance power balanced_pwr, in terms of the second value 6_MAXpwr-E/G^{—}reserved_pwr obtained by subtracting the reserve capacity from the maximum output of the engine 2 in the sixth speed stage for advancement, the sixth speed stage for advancement is shifted to the fifth speed stage for advancement (6-5DOWN). For example, if it becomes impossible to output the value, which is obtained by adding the reserve power reserved_pwr to the balance power balanced_pwr, in terms of the second value 5_MAXpwr-E/G_reserved_pwr obtained by subtracting the reserve capacity from the maximum output of the engine 2 in the fifth speed stage for advancement, the fifth speed stage for advancement is shifted to the fourth speed stage for advancement (5-4DOWN). For example, if it becomes impossible to output the value, which is obtained by adding the reserve power reserved_pwr to the balance power balanced_pwr, in terms of the second value 2_MAXpwr-E/G_reserved_pwr obtained by subtracting the reserve capacity from the maximum output of the engine 2 in the second speed stage for advancement, the second speed stage for advancement is shifted to the first speed stage for advancement (2-1DOWN).

As expressed by the formula (6) for deciding upshift, when the accelerator pedal is released, the value obtained by adding the reserve power reserved_pwr and hysteresis power hys_pwr to the balance power balanced_pwr is selected as a gear shifting decision power. As shown in FIG. 28, an intersection between a curve, which indicates the value obtained by adding the reserve power reserved_pwr and hysteresis power hys_pwr to the balance power balanced_pwr, and a curve indicating any of the maximum powers 1_MAXpwr to 6_MAXpwr in the first to sixth speed stages for advancement is regarded as an upshift shift point.

Specifically, for example, when the first speed stage for advancement is designated, if it becomes possible to output the value, which is obtained by adding the reserve power reserved_pwr and hysteresis power hys_pwr to the balance power balanced_pwr, in terms of the fourth value 2_MAXpwr-E/G_reserved_pwr obtained by subtracting the reserve capacity from the maximum output of the engine 2 in the second speed stage for advancement resulting from upshift, the first speed stage for advancement is shifted to the second speed stage for advancement (1-2UP). For example, when the second speed stage for advancement is designated, if it becomes possible to output the value, which is obtained by adding the reserve power reserved_pwr and hysteresis power hys_pwr to the balance power balanced_pwr, in terms of the fourth value 3_MAXpwr-E/G_reserved_pwr obtained by subtracting the reserve capacity from the maximum output of the engine 2 in the third speed stage for advancement resulting from upshift, the second speed stage for advancement is shifted to the third speed stage for advancement (2-3UP). For example, when the fifth speed stage for advancement is designated, if it becomes possible to output the value, which is obtained by adding the reserve power reserved_pwr and hysteresis power hys_pwr to the balance power balanced_pwr, in terms of the fourth value 6_MAXpwr-E/G_reserved_pwr obtained by subtracting the reserve capacity from the maximum output of the engine 2 in the sixth speed stage for advancement resulting from upshift, the fifth speed stage for advancement is shifted to the sixth speed stage for advancement (5-6UP).

(Shift Points with the Accelerator Pedal Depressed)

In contrast, when the accelerator pedal is depressed, if the request power req_pwr calculated by the request output calculation means 32 is larger than the reserve power reserved_pwr (even when cruise control is executed, if the request power req_pwr is larger), the value obtained by adding the request power req_pwr to the balance power balanced_pwr is, as expressed by the formula (6) for deciding downshift, selected as a gear shifting decision power. As shown in FIG. 29, an intersection between a curve, which indicates the value obtained by adding the request power req_pwr to the balance power balanced_pwr, and a curve indicating the value obtained by subtracting the reserve capacity E/G_reserved_pwr from any of the maximum powers 1_MAXpwr to 6_MAXpwr in the first to sixth speed stages for advancement is regarded as a downshift shift point.

For example, if it becomes impossible to output the value, which is obtained by adding the request power req_pwr to the balance power balanced_pwr, in terms of the second value 6_MAXpwr-E/G_reserved_pwr obtained by subtracting the reserve capacity from the maximum output of the engine 2 in the sixth speed stage for advancement, the sixth speed stage for advancement is shifted to the fifth speed stage for advancement (6-5DOWN). For example, if it becomes impossible to output the value, which is obtained by adding the request power req_pwr to the balance power balanced_pwr, in terms of the second value 5_MAXpwr-E/G_reserved_pwr obtained by subtracting the reserve capacity from the maximum output of the engine 2 in the fifth speed stage for advancement, the fifth speed stage for advancement is shifted to the fourth speed stage for advancement (5-4DOWN). For example, if it becomes impossible to output the value, which is obtained by adding the request power req_pwr to the balance power balanced_pwr, in terms of the second value 2_MAXpwr-E/G_reserved_pwr obtained by subtracting the reserve capacity from the maximum output of the engine 2 in the second speed stage for advancement, the second speed stage for advancement is shifted to the first speed stage for advancement (2-1DOWN).

As expressed by the formula (6) for deciding upshift, when the accelerator pedal is depressed, the value obtained by adding the hysteresis power hys_pwr to the value obtained by adding the request power req_pwr to the balance power balanced_pwr is selected as a gear shifting decision power. As shown in FIG. 29, an intersection between a curve, which indicates a value obtained by adding up the balance power balanced_pwr, request power req_pwr, and hysteresis power hys_pwr, and a curve indicating a value obtained by subtracting the reserve capacity E/G_reserved_pwr from any of the maximum powers 1_MAXpwr to 6_MAXpwr in the first to sixth speed stages for advancement is regarded as an upshift shift point.

Specifically, for example, when the first speed stage for advancement is designated, if it becomes possible to output the value, which is obtained by adding up the balance power balanced_pwr, request power req_pwr, and hysteresis power hys_pwr, in terms of the fourth value 2_MAXpwr-E/G_reserved_pwr obtained by subtracting the reserve capacity from the maximum output of the engine 2 in the second speed stage for advancement resulting from upshift, the first speed stage for advancement is shifted to the second speed stage for advancement (1-2UP). For example, when the second speed stage for advancement is designated, if it becomes possible to output the value, which is obtained by adding up the balance power balanced_pwr, request power req_pwr, and hysteresis power hys_pwr, in terms of the fourth value 3_MAXpwr-E/G_reserved_pwr obtained by subtracting the reserve capacity from the maximum output of the engine 2 in the third speed stage for advancement resulting from upshift, the second speed stage for advancement is shifted to the third speed stage for advancement (2-SUP). For example, when the fifth speed stage for advancement is designated, if it becomes possible to output the value, which is obtained by adding up the balance power balanced_pwr, request power req_pwr, and hysteresis power hys_pwr, in terms of the fourth value 6_MAXpwr-E/G_reserved_pwr obtained by subtracting the reserve capacity from the maximum output of the engine 2 in the sixth speed stage for advancement resulting from upshift, the fifth speed stage for advancement is shifted to the sixth speed stage for advancement (5-6UP).

(Summary of the Third Embodiment)

According to the third embodiment, the value obtained by adding the larger one of the reserve power reserved_pwr and request power req_pwr to the balance power balanced_pwr may be adopted as the first value for use in deciding downshift. The value obtained by adding the hysteresis power hys_pwr to the value obtained by adding the larger one of the reserve power reserved_pwr and request power req_pwr to the balance power balanced_pwr may be adopted as the third value for use in deciding upshift. In a running state in which a vehicle speed is sustained, both prevention of busy shift and improvement in fuel consumption can be achieved based on the reserve power reserved_pwr. In a running state in which a driver requests acceleration, a speed stage can be selected in response to the request power req_pwr.

In points other than the point described in relation to the third embodiment, the constitution, operation, and advantage of the third embodiment are identical to those of the first and second embodiments. An iterative description will be omitted.

### Fourth Embodiment

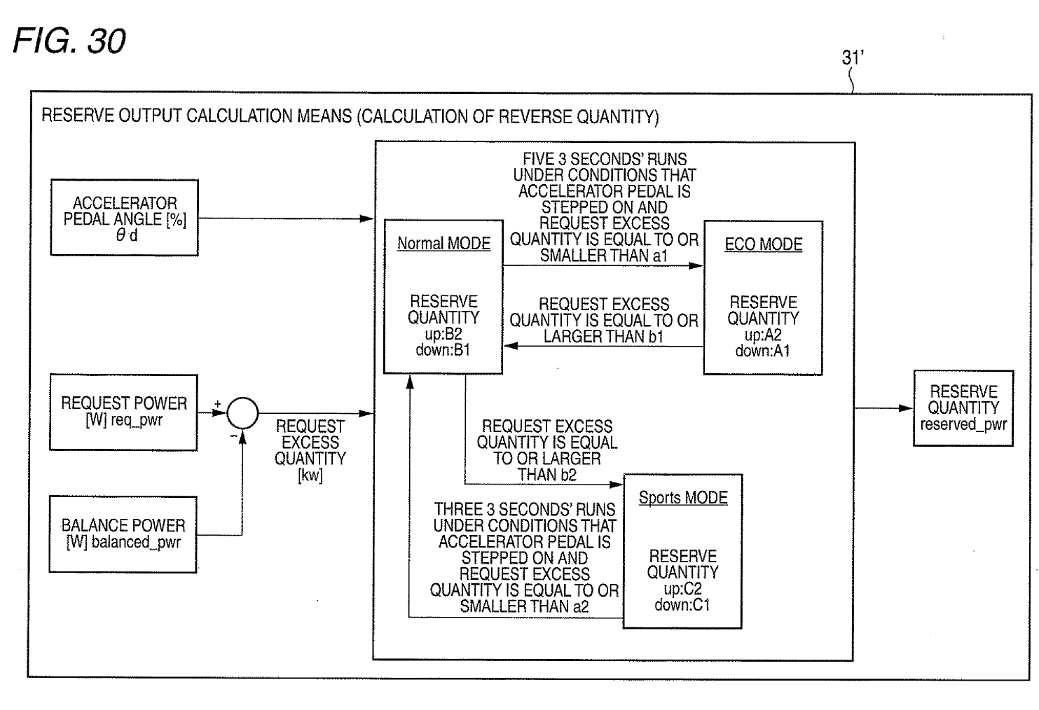

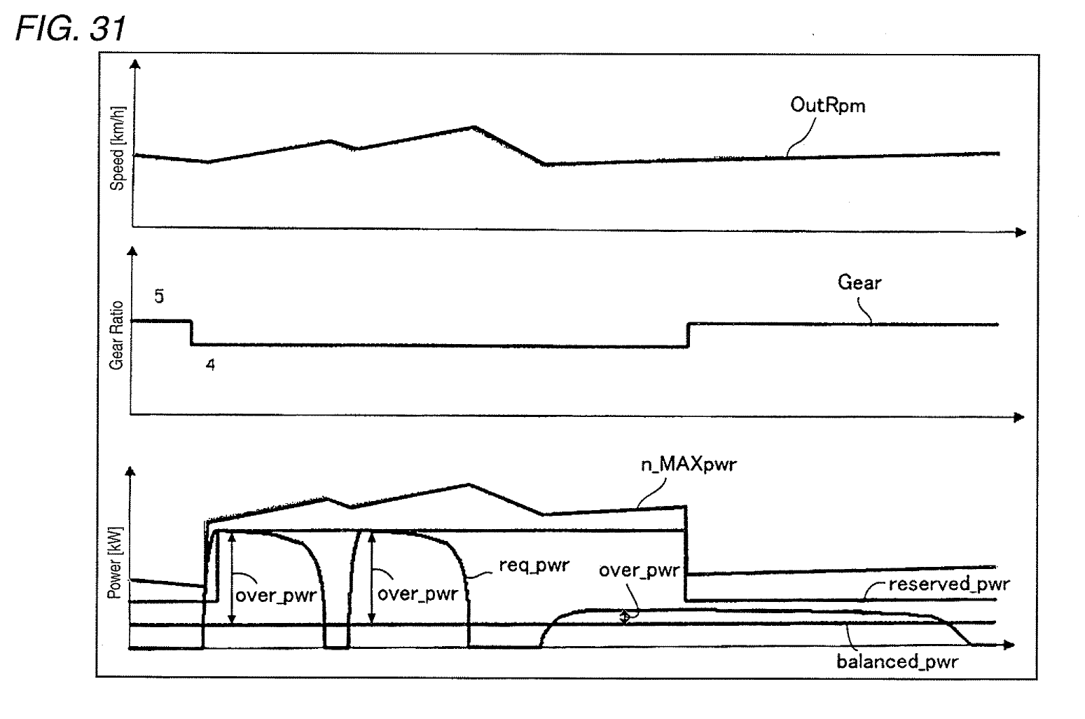

The fourth embodiment that is a modification of the first embodiment will be described in conjunction with FIG. 30 and FIG. 31. In the fourth embodiment, compared with the first embodiment, a computation technique for the reserve power reserved_pwr is modified.

A reserve output calculation means 31′ included in the fourth embodiment switches a normal (Normal) mode, an economic (ECO) mode, and a sport (Sport) mode on the basis of the request excess quantity over_pwr, which is obtained by subtracting the balance power balanced_pwr from the request power req_pwr, and the accelerator pedal angle θd, and adopts as the reserve power reserved_pwr a value associated with each of the modes.

To be more specific, for example, when a vehicle is run in the normal mode, the reserve output calculation means 31′ recognizes that five three seconds' runs are successively achieved (or in other words, a three seconds' run is achieved five successive times) under conditions that the accelerator pedal is stepped on and the request excess quantity over_pwr is equal to or smaller than a first threshold a1 (for example, 1 kw), it means that a state in which a driver does not request acceleration of the vehicle is observed five successive times. Therefore, the normal mode is changed to the economic mode. In the economic mode, the reserve power reserved_pwr for use in deciding downshift (formula (1)) is set to a value A1 (for example, 4 kw), and the reserve power reserved_pwr for use in deciding upshift (formula (2)) is set to a value A2 (for example, 8 kw). The values A1 and A2 are determined to be small values. In other words, the reserve power reserved_pwr to be added to the balance power balanced_pwr is small, and a tolerance is small. Eventually, a speed stage resulting from upshift is likely to be selected, and improvement in fuel consumption is achieved.

For example, when a vehicle is run in the economic mode, if the fact that the request excess quantity over_pwr has become equal to or larger than a second threshold b1 (for example, 23 kw) is recognized, it means that a driver has requested somewhat acceleration of the vehicle. The economic mode is changed to the normal mode. In the normal mode, the reserve power reserved_pwr for use in deciding downshift (formula (1)) is set to a value B1 (for example, 6 kw), and the reserve power reserved_pwr for use in deciding upshift (formula (2)) is set to a value B2 (for example, 12 kw). The values B1 and B2 are determined to be larger than the above values A1 and A2, and smaller than values C1 and C2 to be described later. Namely, the reserve power reserved_pwr to be added to the balance power balance_pwr is a moderate power, and a tolerance is retained at a moderate level. A speed stage resulting from downshift is more likely to be selected than it is in the economic mode. A tolerance for a change in the accelerator pedal angle θd or a change in the running resistance roadR is ensured to some extent, and busy shift is prevented to some extent.

For example, when a vehicle is run in the normal mode, if the fact that the request excess quantity over_pwr has become equal to or larger than a third threshold b2 (for example, 40 kw) is recognized, it means that a driver has requested quick acceleration of the vehicle. The normal mode is therefore changed to the sport mode. In the sport mode, the reserve power reserved_pwr for use in deciding downshift (formula (1)) is set to a value C1 (for example, 16 kw), and the reserve power reserved_pwr for use in deciding upshift (formula (2)) is set to a value C2 (for example, 12 kw). The values C1 and C2 are determined to be larger than the values B1 and B2. Namely, the reserve power reserved_pwr to be added to the balance power balanced_pwr is large, and a large tolerance is ensured. A speed stage resulting from downshift is more likely to be selected than it is in the normal mode. A tolerance for a change in the accelerator pedal angle θd or a change in the running resistance roadR is large. Higher priority is given to prevention of busy shift than to improvement in fuel consumption.

For example, when a vehicle is run in the sport mode, if three 3 seconds' runs are recognized as being successively achieved (or in other words, a three seconds' run is recognized as being achieved three successive times) under conditions that the accelerator pedal is stepped on and the request excess quantity over_pwr is equal to or smaller than a fourth threshold a2 (for example, 2 kw), it means that a state in which a driver does not request acceleration of the vehicle is observed three successive times. Therefore, the sport mode is changed to the normal mode.

The foregoing conditions for mode switching are a mere example. As long as conditions reflect a driver' s intention, any conditions will do.

According to the foregoing calculation of the reserve power reserved_pwr by the reserve output calculation means 31′, when a driver steps on the accelerator pedal so as to accelerate a vehicle while running the vehicle in the normal mode in the fifth speed stage for advancement shown in FIG. 31, the request power req_pwr calculated by the reserve output calculation means 31 increases. Accordingly, the request excess quantity over_pwr calculated by the reserve output calculation means 31′ gets larger. When the request excess quantity over_pwr becomes equal to or larger than the third threshold b2 (for example, 40 kw), the sport mode is decided. The reserve power reserved_pwr is gradually increased to the value C1 and value C2. Meanwhile, the request power req_pwr gets larger than the current gear ratio maximum power 5_MAXpwr (in the fifth speed stage for advancement). According to the formula (1), the downshift decision means 51 decides downshift and shifts the fifth speed stage for advancement to the fourth speed stage for advancement. In the present embodiment, in each mode, the value of the reserve power reserved_pwr is set to different values between downshift and upshift. In the timing chart of FIG. 31, for brevity' s sake, the reserve value is set to one value.

Thereafter, even when the driver steps on the accelerator pedal so as to accelerate the vehicle again, since the sport mode is decided under the foregoing conditions, the value of the reserve power reserved_pwr is sustained. When the reserve power reserved_pwr is set to the large value, compared with when the reserve power reserved_pwr is set to a small value, a speed stage resulting from downshift is likely to be selected. A tolerance that helps decide gear shifting is increased and busy shift is prevented.

Thereafter, when the driver steps on the accelerator pedal to such an extent that the vehicle speed is sustained, the normal mode is decided based on the fact that three 3 seconds' runs are successively achieved under a condition that the request excess quantity over_pwr is equal to or smaller than the fourth threshold a2 (for example, 2 kw) (or in other words, a 3 seconds' run is continuously achieved for nine seconds). The reserve power resereved_pwr is gradually decreased to the value B1 and value B2. If the value obtained by adding up the balance power balanced_pwr, reserve power reserved_pwr (value B2), and hysteresis power hys_pwr gets smaller than the post-upshift maximum power 5_MAXpwr (in the fifth speed stage for advancement), the upshift decision means 52 decides upshift according to the formula (2), and shifts the fourth speed stage for advancement to the fifth speed stage for advancement. When the reserve power reserved_pwr is small, a tolerance that helps decide gear shifting is diminished. However, compared with when the reserve power reserved_pwr is large, a speed stage resulting from upshift is likely to be selected. Improvement in fuel consumption is achieved.

According to the control system 1 for an automatic transmission in accordance with the fourth embodiment, the reserve output calculation means 31′ switches modes so as to stepwise vary the reserve power reserved_pwr. For example, when a driving operation performed by a driver has abruptly changed, or when the running resistance roadR has abruptly changed, the reserve power reserved_pwr can be highly responsively changed from one value to another. Eventually, drivability can be upgraded.

The fourth embodiment has been described to employ three modes. The present invention is not limited to the three modes. Alternatively, a larger number of modes may be employed. In the fourth embodiment, after one mode is changed to another, the reserve power reserved_pwr has been described to be set to a fixed value in the mode. Alternatively, in each mode, the value of the reserve power reserved_pwr may be varied. Especially, in the economic mode, the quick response filter 31a and slow response filter 31b shown in FIG. 9 may be employed. Namely, a constitution having the first embodiment combined with the fourth embodiment is conceivable.

A control system for an automatic transmission in accordance with the present invention may be adapted to an automatic transmission to be mounted in a passenger car, a truck, a bus, agricultural machinery or the like. In particular, the control system is preferably adapted to an automatic transmission requested to improve fuel consumption without impairment of drivability by selecting a gear ratio through computation without use of a shift map.

What is claimed is:

1. A control system for an automatic transmission, in which a gear ratio in a speed changing mechanism, which changes the number of revolutions inputted from a driving source to an input shaft and outputs the resultant revolutions from an output shaft to driving wheels, can be freely changed, the control system comprising:
a sustention output calculation means that calculates a sustention output, which is needed to sustain a vehicle speed, on the basis of a running resistance;
a request output calculation means that calculates a requested request output;
a current gear ratio maximum output calculation means that calculates a current gear ratio maximum output, which is a maximum output of a vehicle at a current gear ratio, on the basis of the maximum output of the driving source;
a post-upshift maximum output calculation means that calculates a post-upshift maximum output, which is a maximum output of the vehicle at a gear ratio resulting from upshift, on the basis of the maximum output of the driving source;
a downshift decision means that when a first value based on the sustention output, the request output, and a reserve output, with which a tolerance for a change in a running situation that helps decide gear shifting is given, gets larger than a second value based on the current gear ratio maximum output, decides downshift to change the gear ratio; and
an upshift decision means that when a third value based on the sustention output, request output, and reserve output gets smaller than a fourth value based on the post-upshift maximum output, decides upshift to change the gear ratio.

2. The control system for an automatic transmission according to claim 1, wherein
the downshift decision means adopts as the first value a larger one of an output, which is obtained by adding the reserve output to the sustention output, and the request output; and
the upshift decision means adopts as the third value an output obtained by adding a predetermined output, which is needed to prevent hunting, to the larger one of the output, which is obtained by adding the reserve output to the sustention output, and the request output.

3. The control system for an automatic transmission according to claim 1, wherein
the downshift decision means adopts as the first value an output obtained by adding up the sustention output and a larger one of the reserve output and request output; and
the upshift decision means adopts as the third value an output obtained by adding up the sustention output, the larger one of the reserve output and request output, and a predetermined output needed to prevent hunting.

4. The control system for an automatic transmission according to claim 1, wherein
the downshift decision means adopts the current gear ratio maximum output as the second value; and
the upshift decision means adopts the post-upshift maximum output as the fourth value.

5. The control system for an automatic transmission according to claim 1, wherein
the downshift decision means adopts as the second value an output obtained by subtracting a reserve capacity, with which the number of revolutions of the driving source can be increased, from the current gear ratio maximum output; and
the upshift decision means adopts as the fourth value an output obtained by subtracting the reserve capacity from the post-upshift maximum output.

6. The control system for an automatic transmission according to claim 1, further comprising a running resistance calculation means that occasionally calculates the running resistance.

7. The control system for an automatic transmission according to claim 1, wherein the request output calculation means calculates a requested request output on the basis of a driving operation.

8. The control system for an automatic transmission according to claim 1, wherein
the control system further comprises a vehicle speed sustention control means that can control a vehicle speed so that the vehicle speed will be retained at a designated target vehicle speed; and
the request output calculation means calculates the request output, which is requested by the vehicle speed sustention control means, as an output needed to accelerate the vehicle until the vehicle speed reaches the target vehicle speed.

9. The control system for an automatic transmission according to claim 1, wherein
the control system further comprises a post-downshift maximum output calculation means that calculates a post-downshift maximum output, which is a maximum output of the vehicle at a gear ratio resulting from downshift, on the basis of the maximum output of the driving source; and
when the post-downshift maximum output is smaller than the current gear ratio maximum output, the downshift decision means inhibits decision of downshift.

10. The control system for an automatic transmission according to claim 2, wherein
the downshift decision means adopts the current gear ratio maximum output as the second value; and
the upshift decision means adopts the post-upshift maximum output as the fourth value.

11. The control system for an automatic transmission according to claim 10, further comprising a running resistance calculation means that occasionally calculates the running resistance.

12. The control system for an automatic transmission according to claims 11, wherein the request output calculation means calculates a requested request output on the basis of a driving operation.

13. The control system for an automatic transmission according to claim 12, wherein
the control system further comprises a vehicle speed sustention control means that can control a vehicle speed so that the vehicle speed will be retained at a designated target vehicle speed; and
the request output calculation means calculates the request output, which is requested by the vehicle speed sustention control means, as an output needed to accelerate the vehicle until the vehicle speed reaches the target vehicle speed.

14. The control system for an automatic transmission according to claim 13, wherein
the control system further comprises a post-downshift maximum output calculation means that calculates a post-downshift maximum output, which is a maximum output of the vehicle at a gear ratio resulting from downshift, on the basis of the maximum output of the driving source; and
when the post-downshift maximum output is smaller than the current gear ratio maximum output, the downshift decision means inhibits decision of downshift.
